(19) United States
(12) Patent Application Publication
(10) Pub. No.: US 2019/0205792 A1
(43) Pub. Date: Jul. 4, 2019

(54) AUTOMATED GENERATION OF WORKFLOWS

(71) Applicant: Intel Corporation, Santa Clara, CA (US)

(72) Inventor: Yen-Min Huang, Cary, NC (US)

(21) Appl. No.: 15/341,819

(22) Filed: Nov. 2, 2016

(51) Int. Cl. G06N 99/00; G06F 9/48

(52) U.S. Cl. CPC G06N 99/005; G06F 9/4881

(57) ABSTRACT

Methods, systems, and computer programs are presented for generating workflows, by a computer program, for a desired task. One system includes a workflow engine and a workflow recommender. The workflow engine is to train a machine-learning algorithm (MLA) utilizing a plurality of learning sequences, each learning sequence comprising a learning context, at least one learning step, and a learning result; receive a workflow definition that includes at least one input context and a desired result, the input context including at least one input constraint; generate, utilizing the MLA, at least one result sequence that implements the workflow definition, each result sequence including a plurality of steps; and select one of the at least one result sequence. The workflow recommender is to cause the selected result sequence to be presented on a display.

### STATEMENT REGARDING FEDERALLY SPONSORED RESEARCH OR DEVELOPMENT

This invention was made with government support under H98230-13D0054 awarded by the National Security Agency. The government has certain rights in the invention.

### TECHNICAL FIELD

The subject matter disclosed herein generally relates to methods, systems, and programs for generating workflows for a desired task.

### BACKGROUND

One trait of human intelligence is the ability to create plans from held knowledge and past experience to achieve an objective. Either recalling a past plan or formulating a new one, this continuous planning and decision-making on what to do next allows us to behave autonomously. However, planning may quickly become a time-consuming exercise for complex tasks, such as when too many sub-tasks are involved and a large number of constraints must be met.

A workflow is a series of activities that are necessary to complete a task. Workflows are everywhere, in manufacturing, business, engineering, and our daily life, and having well-defined workflows may be the difference between success and chaos. The typical process to create a workflow involves a human designer that breaks the task into many steps. However, planning and defining workflows may quickly become a challenging and time-consuming exercise when complexity grows. Also, the more complex the workflow, the harder to test and validate.

### BRIEF DESCRIPTION OF THE DRAWINGS

Various ones of the appended drawings merely illustrate example embodiments of the present disclosure and cannot be considered as limiting its scope.

FIG. 1 is an illustration of an example embodiment of a workflow plan.

FIG. 2 is a flowchart of a method, according to some example embodiments, for testing and training a workflow recommender.

FIG. 3 is an architecture of a system for evaluating the performance of example embodiments.

FIG. 4 is flowchart of a method, according to some example embodiments, for evaluating the performance of a workflow engine.

FIG. 5 illustrates the generation of sequence data, according to some example embodiments.

FIG. 6 illustrates a method for workflow learning, according to some example embodiments.

FIG. 7 illustrates the prediction of the next step utilizing associative memories, according to some example embodiments.

FIG. 8 illustrates a method for recommending possible sequences, according to some example embodiments.

FIG. 9 is a user interface for the workflow recommender, according to some example embodiments.

FIG. 10 illustrates sample test results.

FIG. 11 is a flowchart of a method, according to some example embodiments, for validating the workflow recommender.

FIG. 12 is a high-level architecture of a system for recommending workflows, according to some example embodiments.

FIG. 13 is a flowchart of a method, according to some example embodiments for recommending workflows.

FIG. 14 illustrates the relative attributes defined for each of the steps in a sequence, according to some example embodiments.

FIG. 15 illustrates the assignment of property attributes to components and links, according to some example embodiments.

FIG. 16 illustrates how to connect workflow components, according to some example embodiments.

FIG. 17 shows a workflow with an iteration pattern, according to an example embodiment.

FIG. 18 illustrates how to build a workflow from possible sequences, according to some example embodiments.

FIG. 19 illustrates an example embodiment of a workflow-builder console application.

FIG. 20 is a system for implementing example embodiments.

FIG. 21 is a flowchart of a method for generating workflows, by a computer program, for a desired task.

FIG. 22 is a block diagram illustrating an example of a machine upon which one or more example embodiments may be implemented.

### DETAILED DESCRIPTION

Example methods, systems, and computer programs are directed to generating workflows for a desired task. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

One task for a data analyst is to create workflows that save time by orchestrating a sequence of steps. The embodiments presented provide for a workflow recommender that utilizes machine-learning algorithms to autonomously construct workflow plans that meet specified constraints to achieve a desired result.

The embodiments describe a novel platform for recommending workflow plans to accomplish a task under specified contexts and constraints based on observed samples of workflows. The system recommends workflows to accomplish a task, and the system has been prototyped and evaluated to verify the validity of the results. The system provides one, some or all of the following features:

1. Ability to parse and encode sample workflows (e.g., directed graphs) and associated metadata into collections of attributes having relative encoded positions between steps through a moving window scheme.

2. A collection of matrices called associative memories used to organize, observe, and accumulate the co-occurrences of all attributes. Using associative memories may greatly reduce the number of samples required to achieve high recommendation efficiency in a large problem space.

3. Automatic construction of workflows along with details meeting the given constraints by giving contexts of the task, such as description, tags, strictness, and input/output parameters for the entire workflow.

4. Ability to build workflows by predicting next or previous steps in a sequence (in either the forward or the backward direction), detecting looping patterns, and merging collection of sequences to form workflows.

5. Ability to build sequences by recursively decomposing and adjusting contexts, constraints, and input/output parameters into sub-problems to build subsequences.

6. Reporting of unsolved sub-problems to users for further assistance when the system cannot construct a sequence that meets the required constraints with the given input/output parameters.

The system uses a cognitive thought processes to recall similar (or analogical) experiences from the past, plan a workflow with forward and backward chaining, and represent complex multi-paths and iterative loops. The system also uses adaptive learning to expand the planning space, capture preferences with more examples, and recognize the order and constraints of steps and contexts.

The system also allows for self-managed planning by decomposing sub-goals and exploring plans automatically, refining constraints and managing contexts autonomously, automatically incorporating new contextual information into the planning process, and interact with the user by recognizing and prompting for irresolvable goals.

The testing and evaluation of the system shows that: associative memories are effective in recommending personalized workflow plans with contexts and constraints, the workflow recommender is able to reflect existing and imagine new workflows autonomously, with only moderate training data required, and that the solution is general and can be applied to various domains.

Machine learning is a field of study that gives computers the ability to learn without being explicitly programmed. Machine learning explores the study and construction of algorithms that can learn from and make predictions on data. Such machine-learning algorithms operate by building a model from example inputs in order to make data-driven predictions or decisions expressed as outputs. Although example embodiments are presented with respect to associative memories, the principles presented herein may be applied to other machine-learning algorithms, such as algorithms related to artificial neural networks, Bayesian networks, random forests, linear classifiers, quadratic classifiers, and support vector machines algorithms.

In one aspect, a system for creating a workflow is provided. The system includes a sequence generator, a workflow engine, and a workflow recommender. The sequence generator is to generate a plurality of training sequences. The workflow engine parses the training sequences to extract order of steps in each training sequence, contexts for each step, and constraints for each step. The workflow engine is for training a machine-learning algorithm utilizing the training sequences and the extracted order of steps, contexts, and constraints. The machine-learning algorithm is trained to predict a next step given previous steps, current contexts, current constraints, and a desired result. Further, the workflow recommender is to test a subset of the training sequences. The testing for each training sequence comprises operations to input an input sequence and the desired result to the workflow recommender, to utilize the machine-learning algorithm to build an output workflow by iteratively calculating the next step until the desired result is reached, and to compare the output workflow to the corresponding training sequence, the workflow recommender being evaluated based on the comparing for the subset of the training sequences.

In one aspect, a method is provided for generating workflows, by a computer program, for a desired task. The method includes an operation for training a machine-learning algorithm utilizing a plurality of learning sequences, each learning sequence comprising a learning context, at least one learning step, and a learning result. Further, the method includes an operation for receiving, by the machine-learning algorithm, a workflow definition that includes at least one input context and a desired result, the input context including at least one input constraint. The machine-learning algorithm generates at least one result sequence that implements the workflow definition, each result sequence including a plurality of steps, and selects one of the at least one result sequences. Further, the method includes an operation for causing the selected result sequence to be presented on a display.

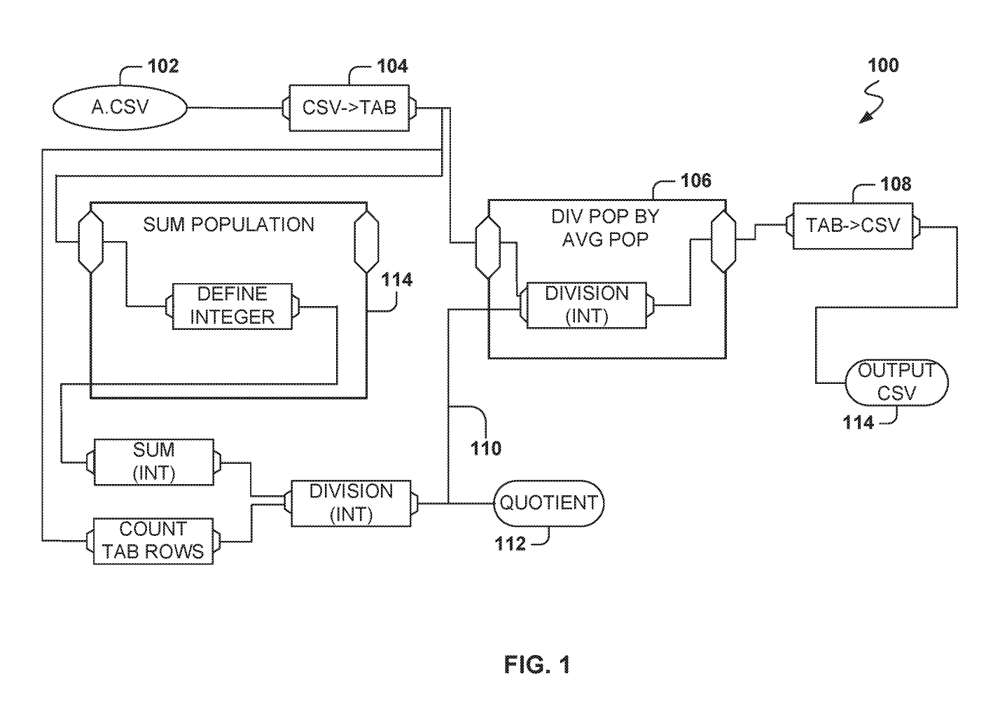

FIG. 1 is an illustration of an example embodiment of a workflow plan. As used herein, a sequence is an ordered list of tasks, also referred to as steps or components. Some sequences include a result (e.g., 112, 114), also referred to as a goal or an output, that is achieved by executing the sequence. A sequence may also be referred to as a workflow in general, but, as used herein, a workflow may also include a directed graph, such as the example illustrated in FIG. 1.

A step (e.g., steps 102, 104, 114, 106, 108) is a task carried out within a sequence (e.g., importing 102 a comma-separated values (CSV) file, converting 104 the format of the CSV file, removing duplicate records). Contexts are task preconditions to the sequence (e.g., source, goals, pre-requisites, project, conditions, results from executing a step, etc.). Additionally, constraints are required preconditions (e.g., contexts, previous steps, etc.) that must be met by the next step, or next steps, in a valid sequence. For example, if a step requires two numbers, a constraint is that the two numbers must be available before the step can be executed.

Each step may receive zero or more inputs and generate one or more outputs. The one or more outputs generated are fed into one or more next steps. There are constraints for how the components are connected and for the selection of the next step, which may depend on the results from the previous step.

Sequence generation refers to the generation of sequence data (e.g., contexts and steps) for training a machine-learning algorithm. Sequence recommendation refers to the construction and recommendation of sequences from given contexts or partial sequences. Further, a workflow recommendation refers to the recommendation of a sequence and the corresponding directed graph to accomplish a task.

The workflow may be represented in a directed graph, where nodes are steps and edges represent the connections between steps that form the sequence. In some example embodiments, there is metadata associated with at least some of the steps and some of the connections, such as names, description, input/output parameters, etc.

In the example illustrated in FIG. 1, a workflow 100 is defined for analyzing census data (input in the form of file A.CSV 102) with population information for different locations to calculate an average age by group and normalizing age data by dividing the ages by the corresponding average to obtain the result 114 in the format of a CSV file.

Constructing a complex workflow, with of a large number of tasks meeting multiple constraints simultaneously, may be a time consuming task for an analyst, especially if there are hundreds or thousands tasks available. Graphic planning tools have been built to assist the analyst, but these tools often require user inputs to select tasks, making the workflow creation process tedious and long. The tools presented create and recommend workflows automatically, and may be used in conjunction with user input to complement the generation process with human input when the tools do not have the right tasks defined to complete a certain workflow.

Further, if the trained workflows are produced by the same user, the user's preferences are also observed and learned by the system, and the system is able to produce personalized workflow recommendations for the user, not only based on the constraints and contexts given, but also based on the user's preferences in constructing workflows.

In some environments, there could be 5000 or more test components to choose from for each step, and the number of steps within the sequence may vary from five to a hundred or more. Given all these choices, constructing workflows may be a daunting task for an analyst. The embodiments presented save time and effort by learning from the workflows already produced by experts, and by recommending operational workflows at least as good as the ones produced by experts.

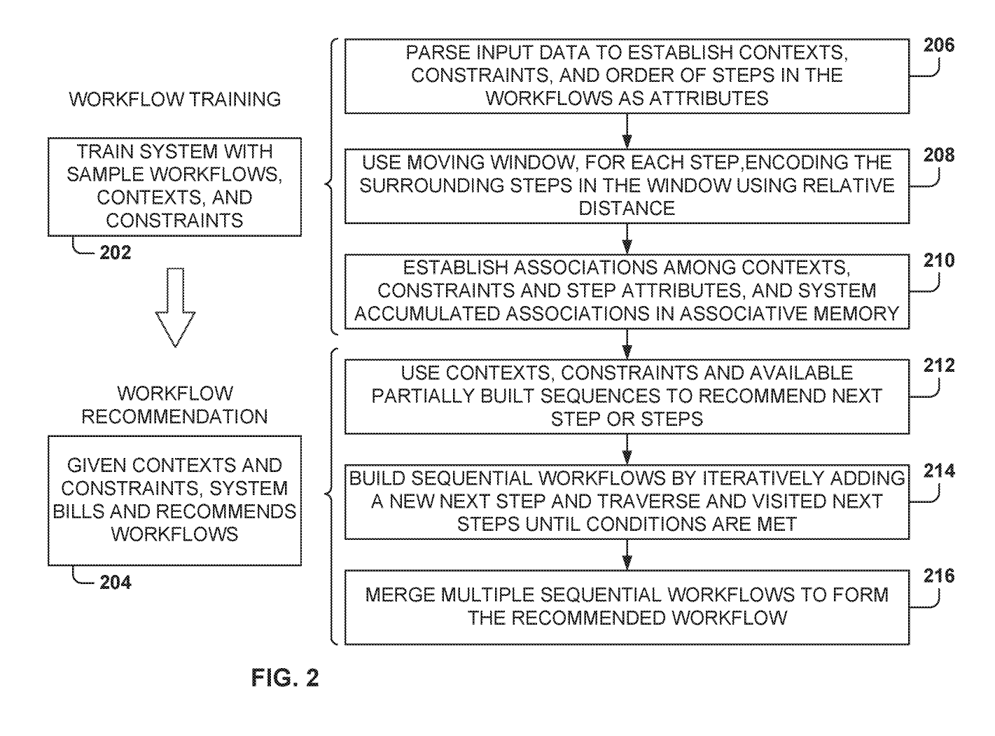

FIG. 2 is a flowchart of a method, according to some example embodiments, for testing and training a workflow recommender. Associative memory is a machine-learning technology that allows learning from past cases and uses the learned material to make predictions. The name associative is because the tool learns by association, similar to how humans learn. For example, if a person sees a friend with another person, an association is made that the other person may be a friend, or family, or a business relationship, or some other type of association for the friend. This information is taken and all the possible associations are made for that person. Further data may reduce the number of possible associations to a smaller set.

Associative Memory is based on sets of matrices, called associative memories, developed by observing co-occurrences of attributes under contexts. An attribute is a tuple of category and value, denoted as <category>:<value>. Attributes may represent anything from concrete objects to abstract concepts, for example, person:john, emotion:happy, component:xyz, etc. Attributes are used to represent, at least, steps, inputs, outputs, conditions, context, metadata, etc.

Before beginning to recommend workflows, a question that has to be answered is, can associative memory be used to learn and recommend workflows? The answer is obtained in a process referred to as “stage 1” or workflow training 202. The second question is, can this technology be used to recommend valid, complex workflows? The answer is obtained in “stage 2” or workflow recommendation 204.

During stage 1, the system is trained with sample workflows, context, and constraints 202. This workflow training 202 includes operations 206, 208, and 210. In operation 206, input data is parsed to establish context, constraints, and order of steps in the workflows as attributes. From operation 206, the method flows to operation 208 where, using a moving window for each step, the surrounding steps are encoded in the window using a relative distance and other parameters.

At operation 210, associations are established among contexts, constraints and step attributes, and the system accumulated associations are kept in the associative memory.

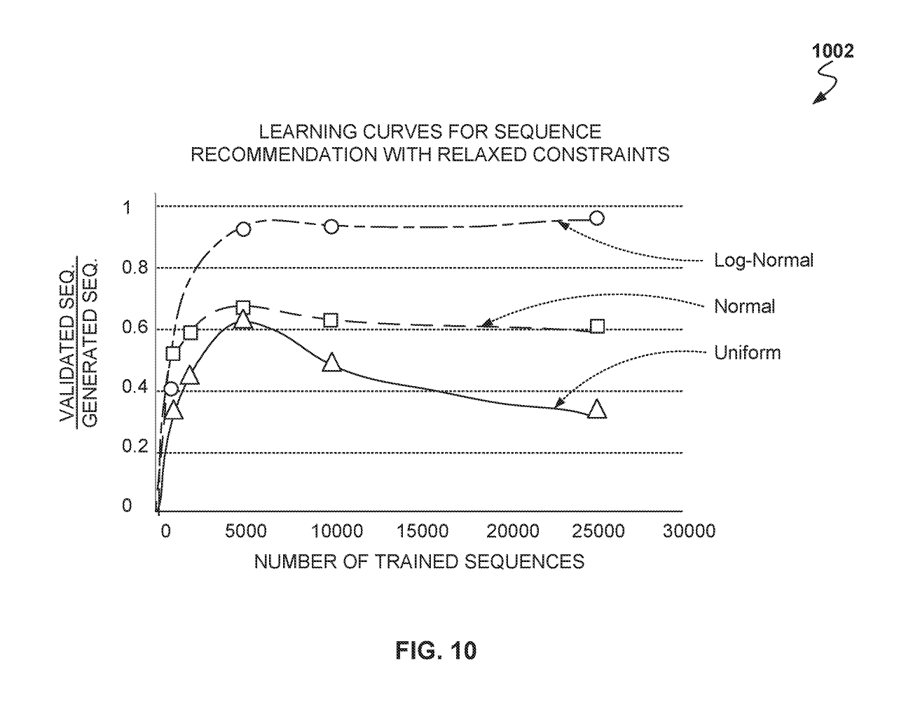

In some example embodiments, sample sequences are learned by the system, and then the system is asked to create a sequence based on related constraints. The results are compared to the original sequences to determine if the system is capable of creating valid sequences. The answer is that the system is capable, as discussed in more detail below with reference to FIG. 10.

The benefit of automated workflow creation is the saving of expert's time by learning from the workflows produced by the experts to recommend valid workflows. The approach includes learning how sample workflows were constructed at the step level, and then mixing, matching, and combining the learned information to predict what to do next in a partially constructed sequence with given contexts, inputs, and outputs. For a complex workflow, the problem is recursively decomposed into simpler sub-problems until the sub-problems may be solved at the component level. Then, all solutions to sub problems are merged to form the final workflow plan.

Operation 204 is for workflow recommendation, which includes recommending workflows given certain contexts, constraints, and desired result. Workflow recommendation 204 includes operations 212, 214, and 216. At operation 212, sequences are built to recommend the next step, or series of steps, using the given contexts, constraints, and available partially built sequences.

From operation 212, the method flows to operation 214 for building sequential workflows by iteratively adding a new next step, while traversing and visiting the next steps until all conditions are met (e.g., the desired result is reached). Further, in operation 216, multiple sequential workflows are merged to form the recommended workflow.

In some example embodiments, stages 1 and 2 may be repeated to fine-tune the system until valid workflows are recommended. While the various operations in this flowchart are presented and described sequentially, one of ordinary skill will appreciate that some or all of the operations may be executed in a different order, be combined or omitted, or be executed in parallel.

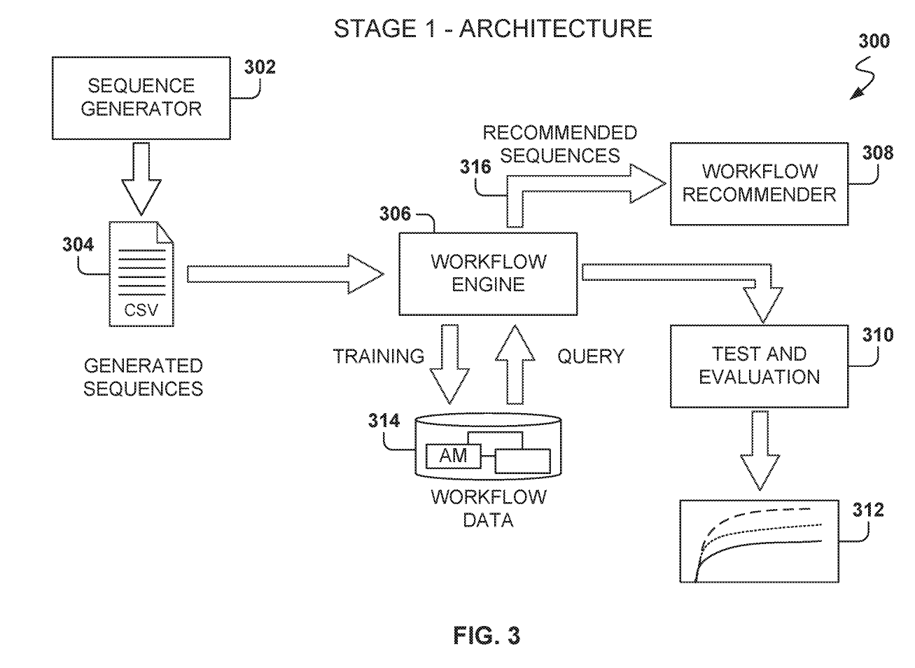

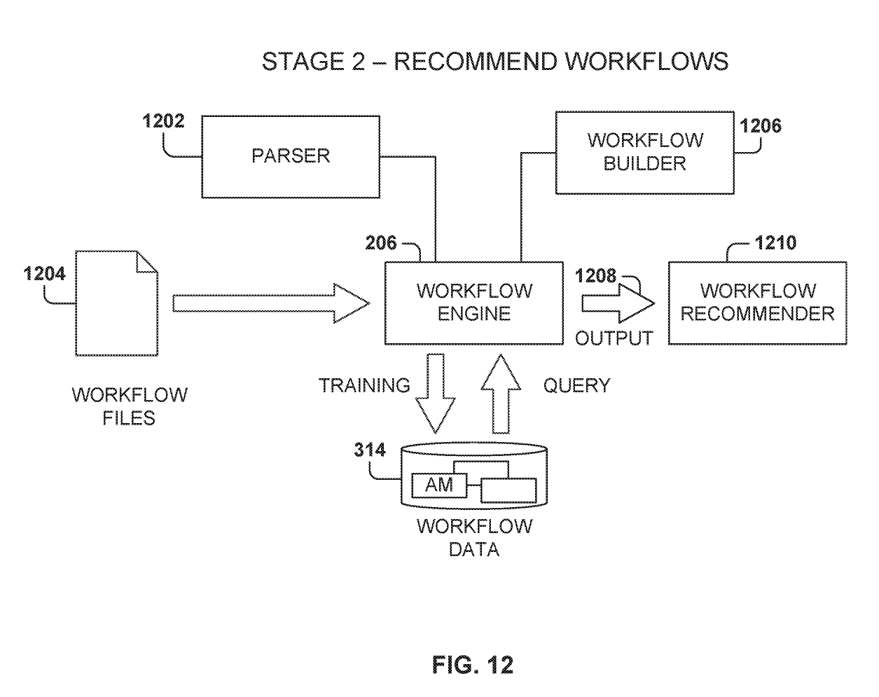

FIG. 3 is an architecture of a system for evaluating the performance of example embodiments. At stage 1, a sequence generator 302 is used to generate training sequences with various distributions to test and evaluate the performance of the algorithm. At stage 2, the algorithm is extended from the generated sequences to learn from actual real human-created workflows, as discussed in more detail below with reference to FIGS. 12 to 19.

Recommending workflows may be a daunting task. For example, let's say an industrial environment includes 5000 different components to choose from at each step, and the average is ten steps per sequence. The number of possible sequences is in the order of 10³⁷. However, in reality, valid sequences are limited by constraints, with a much smaller number of possible sequences, but the number of possible sequences is still quite large.

The approach for using associative memory includes predicting results based on the data observed. There has been a concern about the effectiveness of machine learning for predicting workflows, given the limited size of data and the very large problem space. One of the goals of stage 1 is to determine if the workflow recommendation can be successful for creating workflows with about 20 steps or less. If the approach is validated this way, then it is possible to create workflows with the confidence that the results meet the requirements.

The sequence generator 302 is a program that generates contexts and steps of sequences based on inputs. The input parameters describe the characteristics of the target sequence data. In some example embodiments, the sequence generator 302 creates sequences 304 in CSV format, but any other format for defining sequences may be utilized.

The workflow engine 306 and the machine-learning algorithm are trained with the generated sequences and the workflow data 314 created and stored in the database. After the workflow engine 306 (which interacts with the machine-learning algorithm) has gone through the training process, the workflow engine 306 is ready to receive a query to create a sequence, based on contexts and constraints, to reach a desired outcome.

The workflow engine 306, in response to the query, generates at least one recommended sequence 316. The workflow recommender 308 is a tool that includes a user interface for analyzing the recommended sequences 316.

Further, after a plurality of queries have been processed by the workflow engine 306, a test and evaluation process 310 takes place to determine the validity of the results generated by the workflow engine 306. In some example embodiments, a graphical representation of the results 312 is presented on a display.

A distinction between the sequence generator 302 and the workflow engine 306 is that, although both produce sequences 304, 316, their purpose is different as well as how they generate sequences 304, 316. The sequence generator 302 creates artificial sequences 304 from predefined rules and distributions for training purposes, while the workflow engine 306 creates sequences 316 by querying a trained machine-learning algorithm to meet given constraints and contexts.

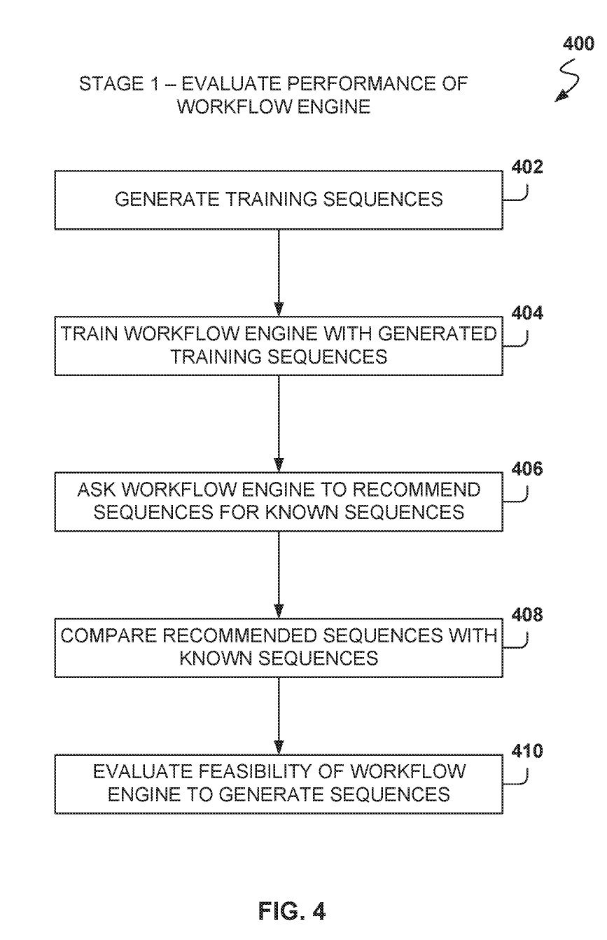

FIG. 4 is flowchart of a method 400, according to some example embodiments, for evaluating the performance of a workflow engine. At operation 402, the sequence generator generates training sequences. From operation 402, the method 400 flows to operation 404 where the workflow engine is trained with the generated training sequences.

At operation 406, the workflow engine is requested to recommend sequences for known sequences. Inputs are provided, which may include a partial sequence, or no sequence at all, and a set of contexts and constraints. The desired result is also entered. This means that the inputs are provided to check if the workflow engine is capable of re-create the sequence. For example, the inputs may include the initial step of the sequence and the contexts and constraints to obtain the desired result.

From operation 406, the method 400 flows to operation 408 where the recommended sequences, created by the workflow engine, are compared to the known sequences created by the sequence generator. In some example embodiments, some testing sequences may also be created manually or retrieved from a known database of existing sequences.

At operation 410, the feasibility of the workflow engine to generate sequences is evaluated based on the comparison from operation 408. More details are provided below regarding the testing results with reference to FIG. 10. With a moderate number of samples trained (proportional to the number of available components), the algorithm achieved 100% accuracy on recalling trained workflows. Based on simulated data generated under log-normal distribution, over 95% of generated unseen workflows were valid. This accuracy can be controlled by tightening or relaxing given constraints and contexts. In addition, the system can automatically fill in the workflow metadata as a byproduct of recalling steps.

While the various operations in this flowchart are presented and described sequentially, one of ordinary skill will appreciate that some or all of the operations may be executed in a different order, be combined or omitted, or be executed in parallel.

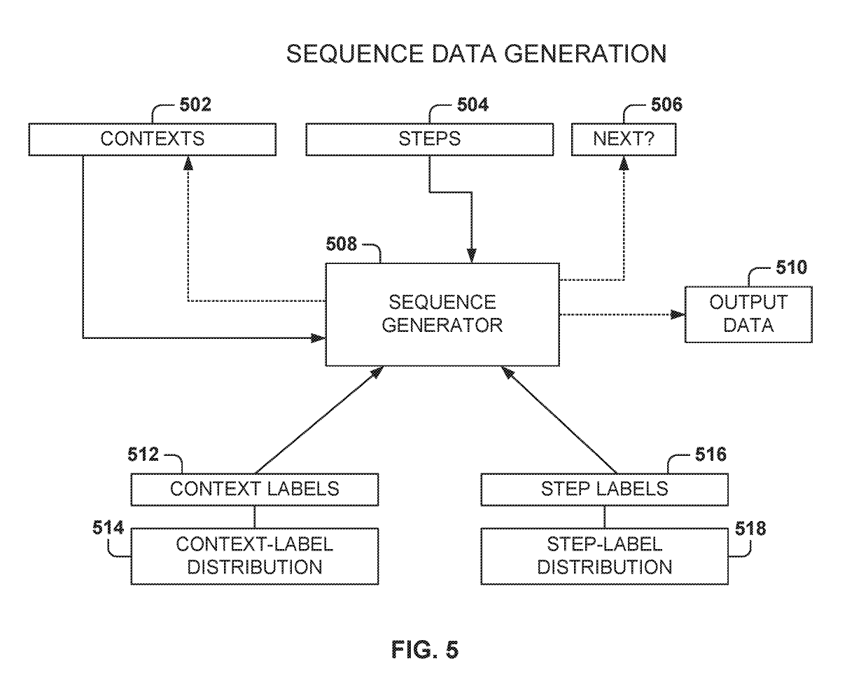

FIG. 5 illustrates the generation of sequence data, according to some example embodiments. The sequence generator 508 creates sequences used for testing and validating the workflow engine 306.

In some example embodiments, the inputs to the sequence generator 508 include contexts 502, steps 504, context labels 512, and step labels 516. The outputs of the sequence generator 508 include a next step 506, contexts 502 for the next step 506, and output data 510. The contexts 502, in an example embodiment, are unordered binary properties representing the metadata or conditions about the sequence. The number of steps in sequences may vary or may be fixed. Further, a maximum number of steps may be defined by the administrator. In some example embodiments, the maximum number of steps and the available task labels can be specified to simulate the scale of the target problem.

The context labels 512 include names representing contexts and a context-level distribution 514, and the context labels 512 are randomly selected from predefined distributions, in some embodiments. The step labels 516 include names representing steps and a corresponding step-level distribution 518. The distributions 514 and 518 specify how labels are drawn from the pool of names or pool of steps. Further, in some example embodiments, the sequence generator 508 includes construction rules for forming sequences.

The sequence generator 508 produces valid sequences according to the received inputs and the predefined construction rules. The construction rules are designed to be deterministic with the introduction of a configurable degree of overlaps or perturbation between steps. This way, a valid step in a sequence may not be valid for other sequences, even when operating under the same context, but the validity of the sequences may still be tested.

In some example embodiments, three distributions were used: log-norm, normal, and uniform. These distributions represent the probability of a task being selected as the next step (provided the task meets the required constraints). In one example embodiment, the same construction rules are used to validate the sequences generated from querying associative memories, as described in more detail below.

In an example embodiment, the following input parameters were used: the total number of sequences to be generated, the total number of task labels available (e.g., 5000), the type of distribution function used to select the task label at each step, the average number of steps in a sequence (e.g., 10), and a context-to-task label ratio (e.g., 25 possible tasks for a given set of contexts).

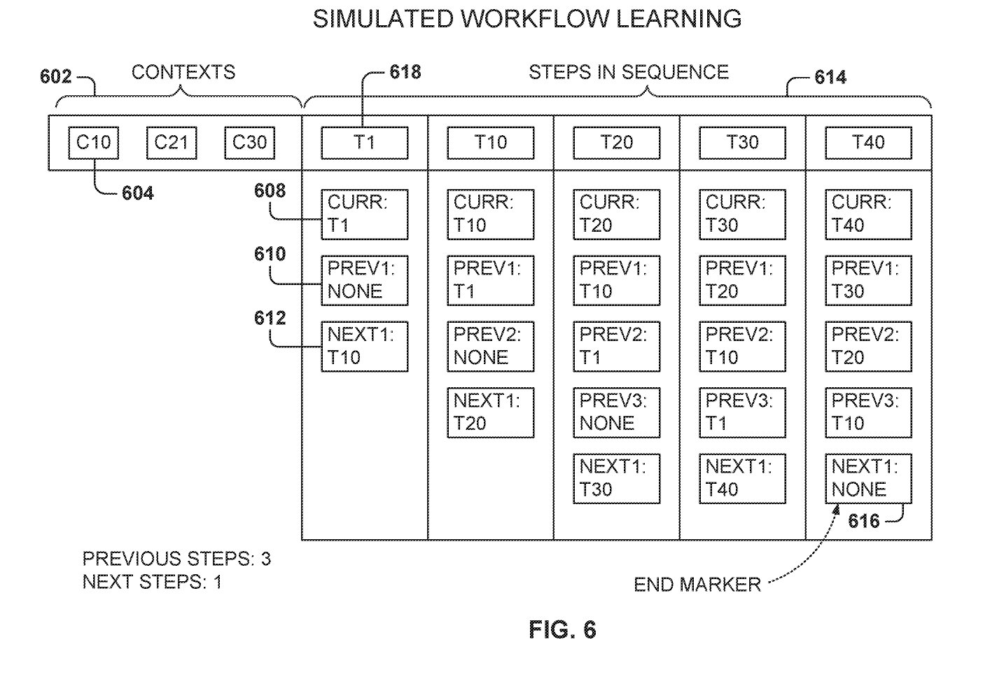

In some example embodiments, the sequence generator 508 operates under the following rules: task labels are numerically encoded (e.g., t<id>:t00001-t05000 as described in more detail below with reference to FIG. 6); the number of steps in sequences is normally distributed (e.g., with an average of 10); no repeating task label is allowed in a sequence: a subset of tasks are valid for a specific step: a predetermined number of task labels (e.g., 5000) are sorted and evenly divided into pools based on the number of steps in a sequence; each step depends on the previous steps and the given contexts; task labels in a valid sequence are in numerically ascending order; the first step depends on the contexts given; contexts are binary encoded as c<id><0|1> (e.g., c10, c21, c31); the number of contexts is determined by a predefined ratio to the number step-1 labels (e.g., 1/25); labels selected at each step follow some distribution function; supported distributions are log-normal, normal, or uniform; and the same distribution function is used for constructing a sequence.

FIG. 6 illustrates a method for workflow learning, according to some example embodiments. The workflow engine 306 learns the relationships between the contexts 502 and the steps 504 before recommending sequences. To facilitate learning the relationships within a sequence 614, the workflow engine 306 creates additional internal attributes through a moving window scheme when processing sequence data. In some example embodiments, a cursor moves within a sequence one step at a time, defining the current step and a window around the current step and determining how many steps before and after the current step are to be observed along with the contexts. The system generates the attributes by imposing the window scheme moving step-by-step to encode relative position of neighboring steps to the current attribute.

Thus, the window includes a predetermined number of previous steps and a predetermined number of next steps. In the example embodiment illustrated in FIG. 6, the predetermined number of previous steps is set to three and the predetermined number of next steps is set to one. However, other embodiments may utilize a different number of predetermined previous steps and predetermined number of next steps.

For each input and output parameter of a step, the properties of the parameter, such as name, data type, required or optional, etc., are represented as attributes and are observed together with the step name. Further, for each connection in the system, a link attribute is created with a unique identifier along the properties of the link, such as names of the source and target steps, connecting source and target parameter names, and the data type.

In some example embodiments, the previous and next steps are encoded as prev<d>:<step_name> and next<d>:<step_name> respectively, where d is an integer indicating how many steps away from the current step, and step_name is the name of the step situated d steps away. For example, prev2:t10 at step t30 indicates that step t10 was two steps before (e.g., previous) in the sequence. Further, next1:t40 at step t30 indicates that the immediate next step in the sequence is t40.

When a window extends beyond the beginning or ending of the workflow, a special keyword “none” is used as the step name. For example, the first step t1 has no previous step, which is coded as prev1:none (of course prev2:none and prev3:none are also implicitly encoded).

The current step is denoted as current:<step_name>. As a result, at each step, there is a set of attributes encoding relative positions of how steps are related. These attributes along with context attributes, representing conditions, and information about the step were observed together into associative memories. By grouping and observing them together, the system learned about the associations of these attributes. In addition to observing the relative positions of steps, the system observes input/output parameters at each step and the connections between steps.

The sequence 614 contains five steps in the order of t001, t010, t020, t030, and t040. At step t1 618, the current step 608 is t1, the prev1 step 610 is “none” encoded as prev1:none, and the next step 612 is t10, which is encoded as next1:t10. The other steps are encoded similarly. At the last step t40, there is no next step, which is encoded as next1:none 616. It is noted that each step, in this example embodiment, includes memory information regarding relationships to previous and next steps.

The contexts 602 include context c10 604, c21, and c30. In some example embodiments, the contexts include text strings, although other embodiments may include different types of context definitions. For example, the contexts 602 may include a string “I want the geographic location.” or “I need to access a database.” or “I want to open a restaurant,” etc.

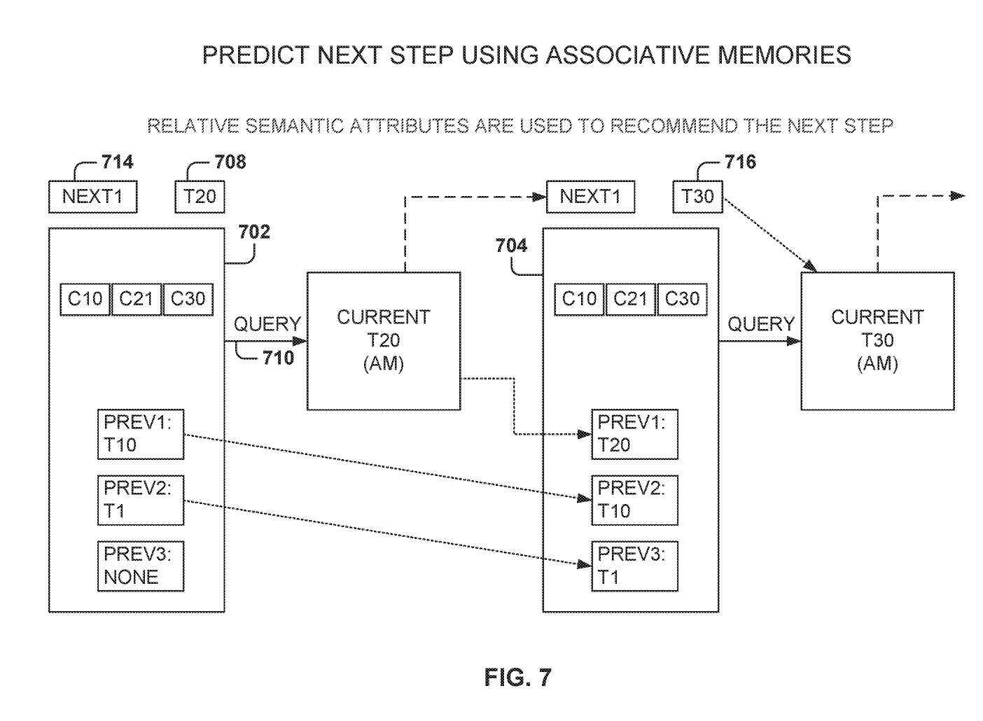

FIG. 7 illustrates the prediction of the next step utilizing associative memories, according to some example embodiments. The workflow engine 306 creates sequences one step at a time; based on the current sequence, the next step is calculated utilizing the machine-learning algorithm. It is noted that the sequence may be built forwards or backwards. The sequence is built forwards when the next step in the sequence is being calculated, while the sequence is built backwards when the previous step in the sequence is being calculated.

In the example embodiment of FIG. 7, the current step t20 708 is encoded 702 with the contexts c10, c21, and c30; prev1 step t10 and prev2 step t1. The associative memory is queried 710 to generate the next step, and the associative memory generates the next step t30 716, where step t20 is encoded with next1:t30. In some example embodiments, the query to the associative memories is to return a ranked list of next-step candidates based likelihood scores between 0 and 1. The scores are computed and normalized based on how many attributes matched in the contexts and previous steps. The more attributes matched by a candidate, the higher the likelihood score.

The next step is encoded, and since the previous step is t20 708, t30 716 gets encoded as prev1:t20, prev2:t10, and prev3:t1. Once a candidate selected as the next step, it becomes the new “current” step, and the contexts and relative attributes are updated to form new set of attributes querying for new next steps. The process is then repeated for t30 716 to calculate the next step until the sequence is completed by reaching the desired goal.

In an example embodiment, the query 710 returns a list of candidate next steps, and the best candidate t30 716 is selected based on the ranking assigned to each of the candidate next steps. Further, next1 field 714 is updated to have a value of t30. Additionally, the contexts at t30 716 are the same as at t20 708, but in other cases, the contexts may also change by adding new contexts, changing current contexts, or deleting some of the current contexts.

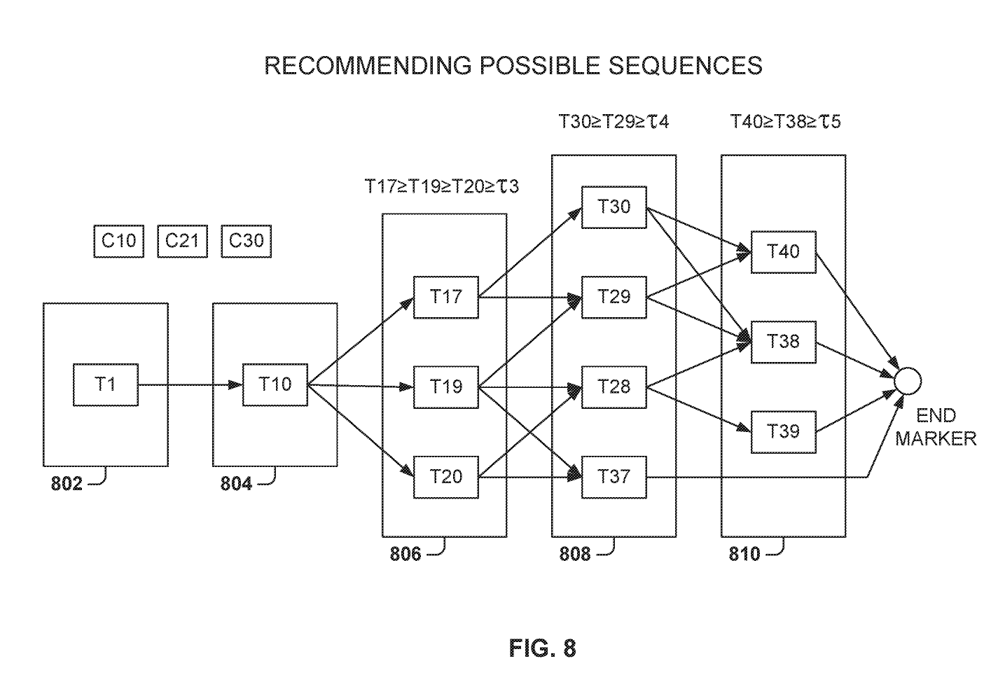

FIG. 8 illustrates a method for recommending possible sequences, according to some example embodiments. At each step, there may be more than one candidate for the next step (e.g., at steps 804, 806, and 808). All the candidate next steps are ranked based on their likelihood scores, and a threshold τ is used to filter out unlikely candidates or candidates with low scores. As the algorithm traverses and selects the next step, the algorithm forms at least one candidate sequence to be recommended. Although higher-scored thresholds produce better sequences, high thresholds may become too limiting and make the algorithm unable to complete a sequence.

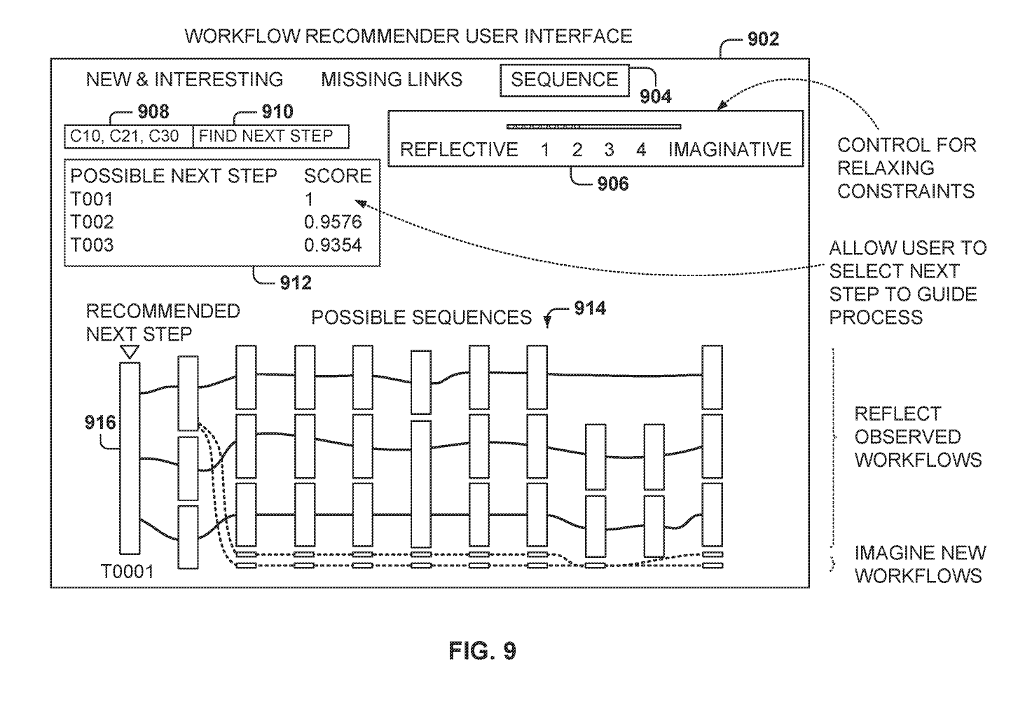

Another factor in determining the quality of the recommended sequences is the number of matching constraints (e.g., contexts and previous steps) for predicting the next step. As more constraints are imposed, the recommended sequences become more reflexive (recollecting observed sequences) rather than imaginative (generating new sequences). However, overly relaxing constraints may lead to producing invalid sequences. Therefore, the workflow recommender 308 provides a sliding bar to let the user control strictness of the constraints to recommend mix of reflexive and imaginative sequences, as illustrated in more detail below with reference to FIG. 9.

In some example embodiments, recommending a valid sequence with a large number of steps (e.g., twenty or more) requires that each individual step meets a high-likelihood threshold (e.g., greater than 0.933 for an average ten-step sequence) in order to achieve a likelihood greater than 50% for creating a valid sequence. In other words, one bad step can easily spoil the whole sequence because the score for the sequence is based on the factorization of the scores for each of the steps in the sequence.

It is noted that some sequences may include subsequences that may be executed in parallel, and the possibilities for the parallel subsequences may be explored in parallel in order to get to the solution faster.

In some example embodiments, when a path is completed (or terminated), the process goes back to the previous step to see if there are more candidates to explore. If there are, the process continues generating more viable paths until all candidates at each position level are exhausted or preset constraints are reached, such as a maximum number of paths or a maximum processing time for generating sequences.

FIG. 9 is a user interface for the workflow recommender, according to some example embodiments. The user interface 902 provides options to the data analyst for entering inputs and interacting with the workflow engine. In some example embodiments, the user interface 902 includes a plurality of screens, such as “new & interesting,” “missing links,” and “sequence” 904. The user interface 902 shows the sequence 904 option selected.

The user interface 902 provides an option 908 for entering contexts, an option 910 for requesting the tool to find the next step, and an option 906 for controlling the constraints, from reflective to imaginative (e.g., from 0 to 5). Additionally, the user interface 902 includes an option 912 for selecting the next step from a plurality of candidate steps. This way, the data analyst may interface with the tool to create a sequence step-by-step. In another option (not shown), the data analyst is able to request the tool to create a complete sequence given the context and constraints. The tool provides a graphic user interface with the possible sequences 914, where the sequences can be reflective or imaginative.

For example, a request is entered to create a workflow for building a taco restaurant. The constraints may include items such as “build the restaurant,” “taco restaurant.” “in California.” and “with at least 33% Hispanic population in town.” A way to relax the constraints would be by specifying, “in California or in Texas.” Further, a way to increase the constraints would be by adding a constraint such as “city population greater than 200,000.”

It may happen that the workflow engine may get to a point where the workflow engine cannot find a next step (e.g., the workflow engine has not been trained with the step to perform certain task). As a response, the workflow engine may present the problem to the analyst stating, “if you show me how to do this step, then I can solve the problem and build a complete sequence.” The system analyst may then provide a task to the workflow engine in order to perform the missing link.

FIG. 10 illustrates sample test results. In an example embodiment, three tests were utilized to evaluate the performance of the sequence recommendation algorithm: the recollect test, the precision test, and the learning-curve test.

The recollect test is a baseline test to check whether the algorithm is able to recommend sequences that have been observed under the following conditions: 25,000 sequences trained under three distributions with up to three previous steps encoded, utilizing strict constraints with a threshold of 0.9 to test if every step in a trained sequence may be recommended. The tests show that that all trained sequences were recollected, regardless of the training data sizes and distributions.

The precision test measures the quality of the recommended sequences according to the following precision definition:

$$precision = \frac{{N}_{valid}}{{N}_{recommended}}$$

Where N_{valid} is the number of valid sequences recommended and N_{recommended} is the total number of recommended sequences. Two sets of tests were utilized, one with strict constraints (test I) and another one with relaxed constraints (test II). In an example embodiment, the precision test includes the following operations:

1. Randomly generate contexts.

2. Apply strict (test I) or relaxed (test II) constraints and thresholds to select next-step candidates. For test I, recommend steps associated with all contexts and previous three steps. For test II, recommend steps associated with at least one context and at least one previous step.

3. Build sequences by randomly selecting from top five candidates at each step until the end marker is recommended. The process gives up if the recommender cannot complete a sequence due to either no viable candidates found or too many branches beyond a predetermined threshold have been tried.

4. Terminate a sequence when the maximum number of steps has been reached, even if the end marker has not been reached.

5. Validate recommended sequences against the rules used by the sequence generator.

The following table summarizes the results of the precision tests with training data generated under three different distribution functions:

TABLE 1

| | Test I—Strict | | | Test II—Relaxed | | |
|---|---|---|---|---|---|---|
| | Matching | | | Matching | | |
| | (τ = 0.9) | | | (τ = 0.5 to 0.75) | | |
| # | Log- | | | Log- | | |
| Trained | Norm | Normal | Uniform | Norm | Normal | Uniform |
| 1000 | 0.99 | 1 | 0.974 | 0.402 | 0.517 | 0.352 |
| 2000 | 0.99 | 0.996 | 0.995 | 0.592 | 0.586 | 0.446 |
| 5000 | 0.983 | 0.997 | 0.996 | 0.928 | 0.667 | 0.643 |
| 10000 | 1 | 0.995 | 1 | 0.929 | 0.626 | 0.488 |
| 25000 | 0.994 | 1 | 1 | 0.969 | 0.608 | 0.347 |

It was observed from the test results that, when recommending the steps associated with all contexts and the previous three steps (test I), that in about 60% to 68% of the attempts, complete sequences were recommended within the time limit. Further, the recommended sequences were almost 100% valid; for all distributions, all valid sequences recommended were observed previously. This answered the question, “if I request a new workflow based on the tasks that you learned, can the workflow engine produce a valid workflow?” The answer was positive, as the recommended workflows were valid, proving that the workflow engine can generate valid sequences.

The precision test with relaxed matching required matching at least one context and at least one previous step. When recommending steps associated with at least one context and at least one previous step (test II), 100% completion rate was achieved with almost none of the recommended sequences having been observed before. Additionally, the precision varied depending on the size of the training data.

The learning curve test measured the precision under different training data sizes and distributions. Chart 1002 illustrates the results for the learning curve test, where the x axis is for the number of trained sequences, and the y axis is for the precision value. The three curves correspond to the log-normal, normal, and uniform distributions. As it is to be expected, the log-norm distribution performs best given that the selection of the next step is preferential. On the other hand, the lowest precision occurred when the choice was uniform and random.

The learning curves show that the best precision was reached with about 5000 sequences trained. Depending on the distribution used, the precision varied and dropped after 5000 trained sequences. It is believed that the drop is due to having more invalid candidates available for selection under the same relaxed constraints as the training data grows. The decrease of the precision may be remedied by requiring stricter constraints, which implies a trade-off to a lower rate for finding sequences.

The conclusion derived from the testing was that by adjusting the number of required constraints and the threshold for selecting the next step candidates, it is possible to control the validity and the quality of the recommended sequences toward either reflexive or imaginative sequences. Further, the training set required around 5000 sequences, but it is to be appreciated that under different circumstances (learning sequences, tests performed), the number may be higher or lower. Further yet, the task selection is often preferential (following log-normal distribution), and the algorithm maintains a high recommendation precision (greater than 92%) over a wide range of training data sizes under the distribution.

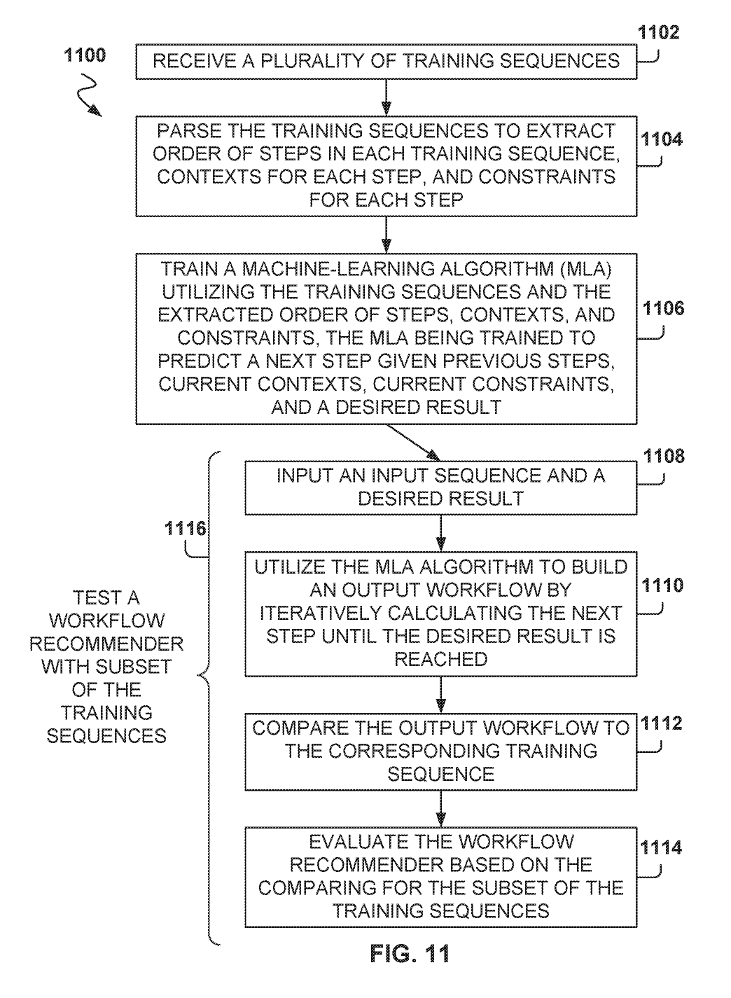

FIG. 11 is a flowchart of a method 1100, according to some example embodiments, for validating the workflow recommender. At operation 1102, a plurality of training sequences is received by the workflow engine. In an example embodiment, the training sequences are generated by the sequence generator.

From operation 1102, the method 1100 flows to operation 1104, where the training sequences are parsed to extract an order of steps in each training sequence, contexts for each step, and constraints for each step. At operation 1106, a machine-learning algorithm is trained utilizing the training sequences and the extracted order of steps, contexts, and constraints. The machine-learning algorithm is trying to predict a next step given previous steps, current contexts, current constraints, and a desired result. In some example embodiments, the machine-learning algorithm includes associative memories, but other embodiments may utilize other machine-learning algorithms.

From operation 1106, the method flows to operation 1116 to test the workflow recommender with a subset of the training sequences. Operation 1116 includes operations 1108, 1110, 1112, and 1114. At operation 1108, and input sequence and a desired result are inputs into the workflow recommender. At operation 1110, the machine-learning algorithm is utilized to build an output workflow by iteratively calculating the next step until the desired result is reached.

From operation 1110, the method 1100 flows to operation 1112 to compare the output workflow to the corresponding training sequence. At operation 1114, the workflow recommender is evaluated based on the comparison at operation 1112 for a subset of the training sequences.

FIG. 12 is a high-level architecture of a system for recommending workflows, according to some example embodiments. In stage 2, several new features are introduced. In some example embodiments, the approach to workflow recommendation is changed from working with generated sequences to actually recommending workflows based on real-life workflow data.

As used herein, real-life workflow data, also referred to as real workflows, is data for actual workflows generated by experts to perform real-life tasks. The real workflows are parsed to construct directed workflow graphs and to establish the order of steps used within the workflow.

Additionally, at each step additional input and output contexts and related tags are made available, such as by connecting the output of a step to the input of the next step and by producing an inventory of observed components, connections, and metadata.

In addition, the workflow engine 306 is improved to learn multiple concurrent previous or next steps and iteration patterns. Further, the workflow recommendations are enhanced by: enriching query context with required inputs or outputs, operating queries in either the forward or the backward direction, detecting repeated patterns to identify iterators, building workflows by merging multiple sequences, and filling in the property details for workflow components and links.

The user exports existing workflow files 1204 as the training data for the workflow engine 306. The workflow engine 306 parses the workflow files 1204 utilizing parser 1202 and trains the associative memories 314 utilizing the parsed workflow files.

The analyst directs the workflow builder 1206 by supplying the query with the contexts and initial constraints for creating a recommended workflow with a desired result. The workflow recommender 1210 recommends the resulting workflows 1208, which can be stored in database 314 or presented on the user interface.

In some example embodiments, the workflow files 1204 utilize the JSON structured format for describing the workflows, but other types of formats may be used. The parser 1202 parses the workflow files according to their format. Thus, instead of a sequence generator as described in FIG. 3, the parser 1202 is used to parse the workflow files 1204 with additional attributes for observing the structure and metadata in the workflow.

The enhanced workflow builder 1206 responds to client's input to construct workflow plans. The output 1208 is, in an example embodiment, in the JSON format containing components and connections information for the recommended workflow.

The workflow recommender 1210 produces a directed graph of steps (including iterative patterns, if any) that meets the given constraints. Using real workflow data adds complexity because of additional metadata and input/output constraints that may be defined between steps.

To validate that the workflow recommender 1210 may operate with real data, various workflows performing analytics tasks were produced as the training data. After the training, it was verified that the workflow recommender 1210 was able to output valid workflow plans, including the training workflows, for a given task with contexts and constraints specified. The workflow models used for training data covered a wide range of tasks and data such as geospatial, SQL, population census, set intersection, Keyhole Markup Language (KML), ellipse geometry, arithmetic, data manipulation, and data conversion.

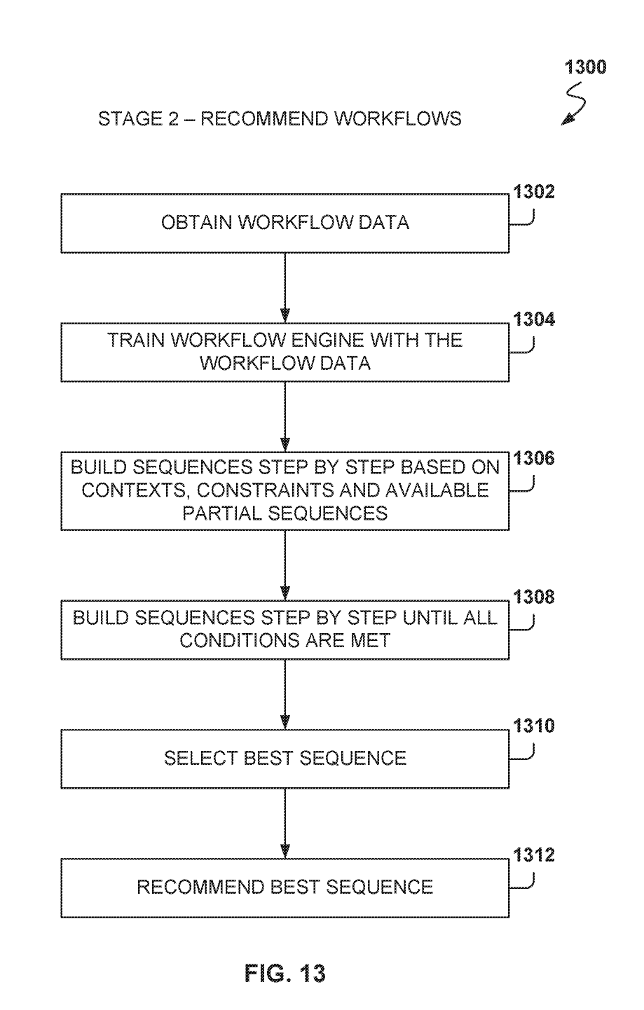

FIG. 13 is a flowchart of a method 1300, according to some example embodiments for recommending workflows. Operation 1302, workflow data is obtained (e.g., workflow files 1204 of FIG. 12). From operation 1302, the method 1300 flows to operation 1304, where the workflow engine is trained with the workflow data.

From operation 1304, the method 1300 flows to operation 1306 for building sequences step-by-step based on context, constraints, and available partial sequences. At operation 1308, the sequences are built step-by-step until all conditions are met. From operation 1308, the method 1300 flows to operation 1310 where the best sequence is selected from a plurality of candidate built sequences. At operation 1312, a sequence is recommended based on the selected best sequence. In addition, a workflow may be recommended based on the selected sequence.

For example, a sequence is desired for “opening a restaurant in San Francisco.” The last step may be to open the restaurant, but before opening the restaurant, it may be needed to get a license, buy the furniture, build the restaurant, bring in the food, train the waiters, etc. In one example embodiment, it is possible to move backward from the last step “open restaurant,” and find out the previous steps required to get to this last step.

The analyst may come back to the tool with further refinements because the results were not as expected, e.g., not enough customers came to the restaurant. Although the sequence may have been correct in which a restaurant was opened, the analyst may add additional constraints in order to get better results, such as, “develop a marketing campaign” or “build restaurant in the city with more than 1 million inhabitants.” Therefore, in some cases, the process may be iterative until the desired workflow is obtained. Further, metadata may be added to the inputs. For example, the owner may provide a name, address, and telephone number, which are not necessarily related to opening a restaurant but it is information related to the task.

While the various operations in this flowchart are presented and described sequentially, one of ordinary skill will appreciate that some or all of the operations may be executed in a different order, be combined or omitted, or be executed in parallel.

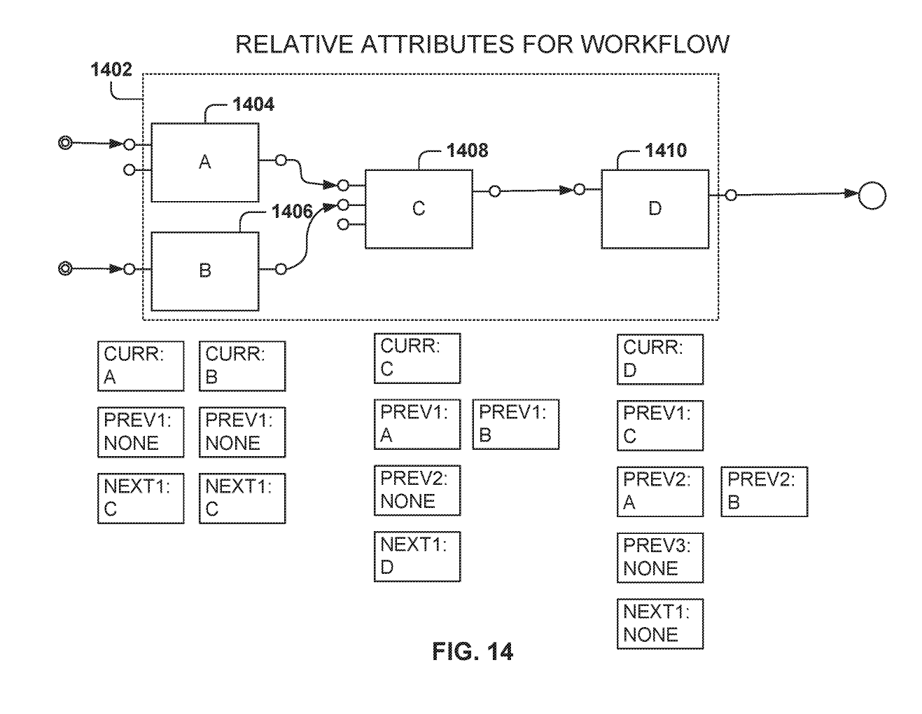

FIG. 14 illustrates the relative attributes defined for each of the steps in a sequence, according to some example embodiments. At stage 2, one task may have more than one predecessor. In the example of FIG. 14, task C 1408 has two predecessors: task A 1404 and task B 1406. Both task A 1404 and task B 1406 have outputs that are connected to respective inputs of task C 1408.

When encoding this partial sequence 1402, both tasks A 1404 and B 1406 have next1:C because task C 1408 is the next task following. Further, task C 1408 has two prev1 fields, prev1:A and prev1:B, to indicate the two immediate predecessors. Further, task D 1410 has two prev2 fields: prev2:A and prev2:B.

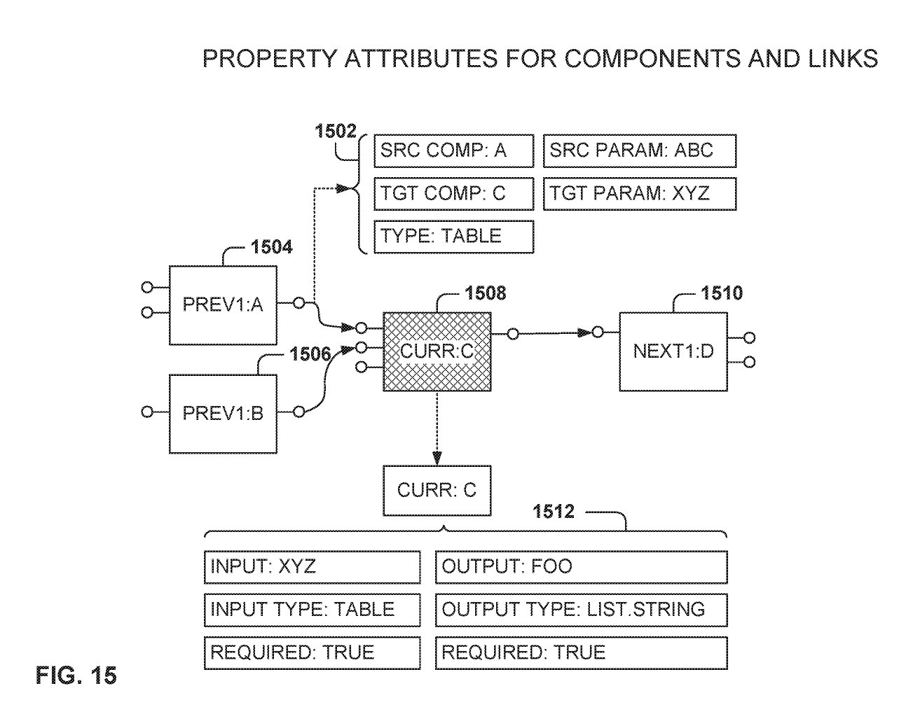

FIG. 15 illustrates the assignment of property attributes to components and links, according to some example embodiments. Property attributes may be defined for links between tasks and for the tasks. For each component, there are additional attributes representing the names and types of the input/output parameters. Further, for each link, the following may be defined: connecting type, source and target parameters, and the source and target components containing these parameters. Of course, inputs connected to outputs have to match, otherwise the sequence will not be valid. If a task needs an integer, the task must receive an integer, and other input types (e.g., a real number) would not work to connect the tasks together.

FIG. 15 illustrates the definition of attributes, with C 1508 being the current task, tasks A 1504 and B 1506 being the previous tasks, and task D 1510 being the next task. For example, link 1502 joining the output from task A 1504 to the input of task C 1508 includes the following attributes: (source component: A). (target component: C), (source parameter: ABC), (target parameter: XYZ), and (type: table). This means that the source parameter ABC is provided by task A 1504 as the source, ABC being a table, which is coupled to parameter XYZ at task C 1508.

Further, task C 1508 is encoded 1512 with the following input: (input parameter: XYZ), (input type: table), (required input: true). The output is encoded 1512 as: (output: FOO). (output type: list.string), and (required output: true).

It is noted that the embodiments illustrated in FIG. 15 are examples and do not describe every possible embodiment. Other embodiments may utilize different encodings, different types, different nomenclature, etc. The embodiments illustrated in FIG. 15 should therefore not be interpreted to be exclusive or limiting, but rather illustrative.

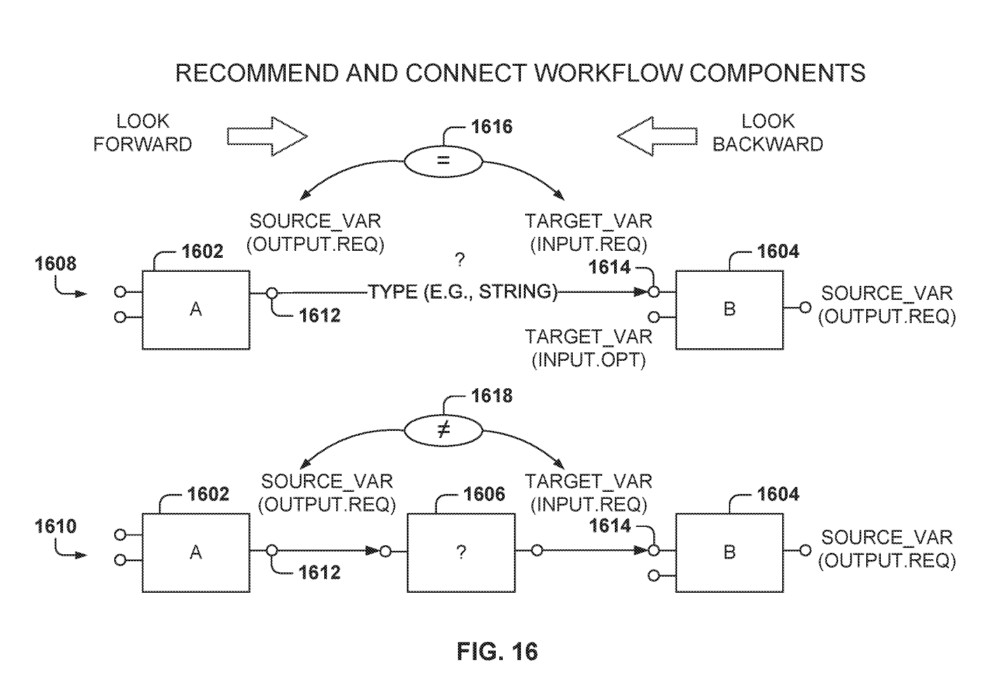

FIG. 16 illustrates how to connect workflow components, according to some example embodiments. Sequences can be created step-by-step going either forward or backwards given certain input parameters. In some example embodiments, creating the sequence is broken into sub-problems by decomposing the original problem into the sub-problems with updated contexts and goals. The system then proceeds to solve all the sub-problems.

FIG. 16 illustrates a problem to connect components A 1602 with component B 1604. The output 1612 from component A 1602 is checked for compatibility with the input 1614 at component B 1604. If the input 1612 and output 1614 are of the same type 1616 (e.g., a string), then one solution to the problem is to directly connect A 1602 to B 1604, although other solutions may exist. Connecting A 1602 directly to B 1604 may be, or may not be, the optimal solution depending on contexts and constraints.

As the problem is solved, the flow engine calculates the probability that each component is the right component for the next step (or for the previous step if going backwards). In this case, a score is calculated for the probability that connecting A 1602 to B 1604 is the best solution. If there is a better solution for connecting A 1602 to B 1604, then the workflow recommender may insert a component or a subsequence between A 1602 and B 1604, even though a direct connection is possible.

In some example embodiments, the score is based on the number of times that this connection has been observed by the system (e.g., from the training data) and by the surrounding parameters for A 1602 and B 1604. If the system has seen this connection several times (or many times), then the connection will receive a high score because this is a good connection to make based on experience.

On the other hand, if the output 1612 of A 1602 is different 1618 from the input 1614 of B 1604, then a component or a subsequence 1606 must be added between them, such as the component or subsequence 1606, which has an input compatible with the output 1612 of A 1602 and has an output compatible with the input 1614 of B 1604. In some example embodiments, the machine-learning algorithm is utilized to identify what component should be included between A 1602 and B 1604.

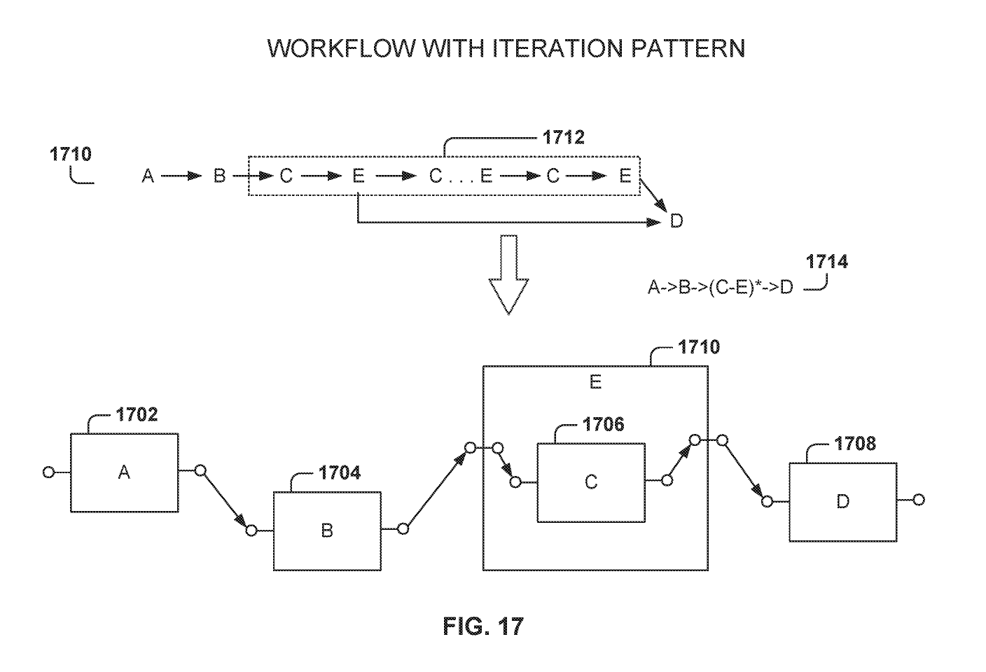

FIG. 17 shows a workflow with an iteration pattern, according to an example embodiment. While creating a sequence, it is beneficial to identify repeating patterns to prevent from falling into infinite loops.

In the example of FIG. 17, sequence 1710 includes a repeating pattern 1712 where components C and E alternate. In an example embodiment, the repeating pattern is represented by enclosing the pattern in parenthesis and adding a “*” sign after the closing parentheses. Further, to represent a sequence as text, the sequence is represented as the components separated by “->” (an arrow). Therefore, sequence 1710 including steps 1702, 1704, 1710, and 1708, may be represented 1714 in a string as A->B->(C−E)*->D.

Graphically, the iteration may be represented as a component 1710 for task E with component C 1706 embedded within, in some example embodiments. This simplifies the user interface by uncluttering the representation of the workflow, instead of having to repeat the same pattern multiple times.

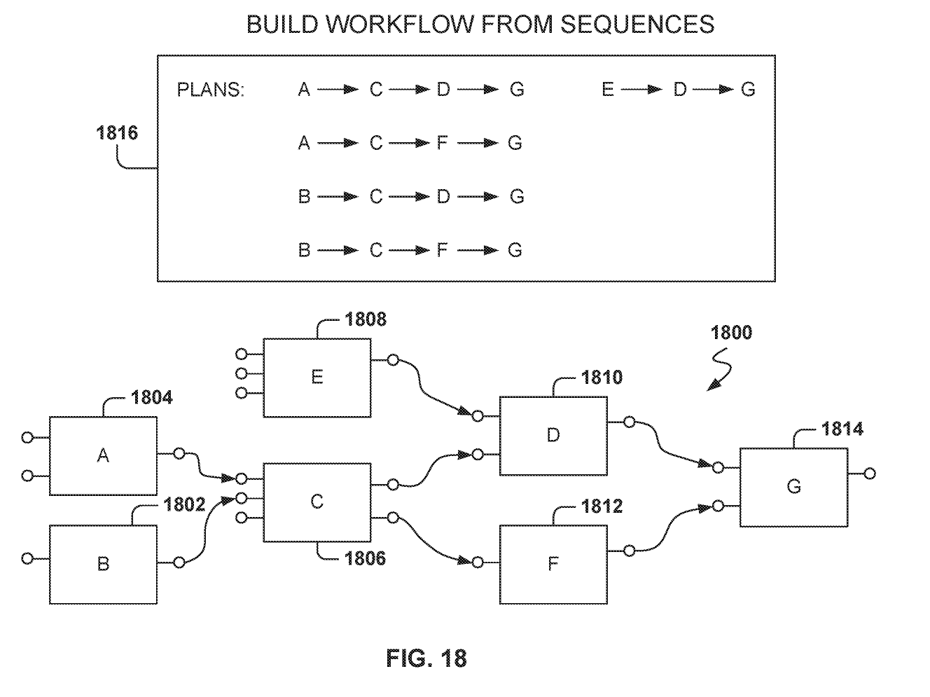

FIG. 18 illustrates how to build a workflow from possible sequences, according to some example embodiments. At this stage, in some example embodiments, multiple recommended sequences 1816 are merged into a single workflow 1800. In the example of FIG. 18, five sequences 1816 are being recommended: A->C->D->G; A->C->F->G: B->C->D->G; B->C->F->G; and E->D->G.

In an example embodiment, creating the workflow begins with one of the longest paths (e.g., A->C->D->G), which is referred to as the trunk. Therefore, the initial workflow includes components A 1804. C 1806. D 1810, and G 1814. Afterwards other paths are added, aligning them with the trunk as much as possible by identifying the longest span of overlapped steps between the current workflow and the new sequence to be added. Then, the rest of non-overlapping components are attached as branches to the trunk.

A->C->F->G is added next, therefore, component F 1812 is added to the workflow 1800 and then F 1812 is connected between C 1806 and G 1814. The next sequence added is B->C->D->G, and since C->D->G is already present, B 1802 is added to the workflow and then the required inputs and outputs connected. B->C->F->G is added next, which does not require any changes to the workflows since the sequence is already in the workflow. Finally, the sequence E->D->G is added, and since D->G already exists. E 1808 is added to the workflow 1800 and the output of E 1808 is connected to the input of D 1810.

In an example embodiment, the user is given control to decide if a sequence is merged or not. For example, the user may decide that the user does not like component E 1808, so sequence E->D->G is not added to the workflow 1800.

In an example embodiment, when all the sequences are merged, the workflow recommender outputs the workflow 1800 in a predefined format for further downstream processing, such as the same format used to receive the input.

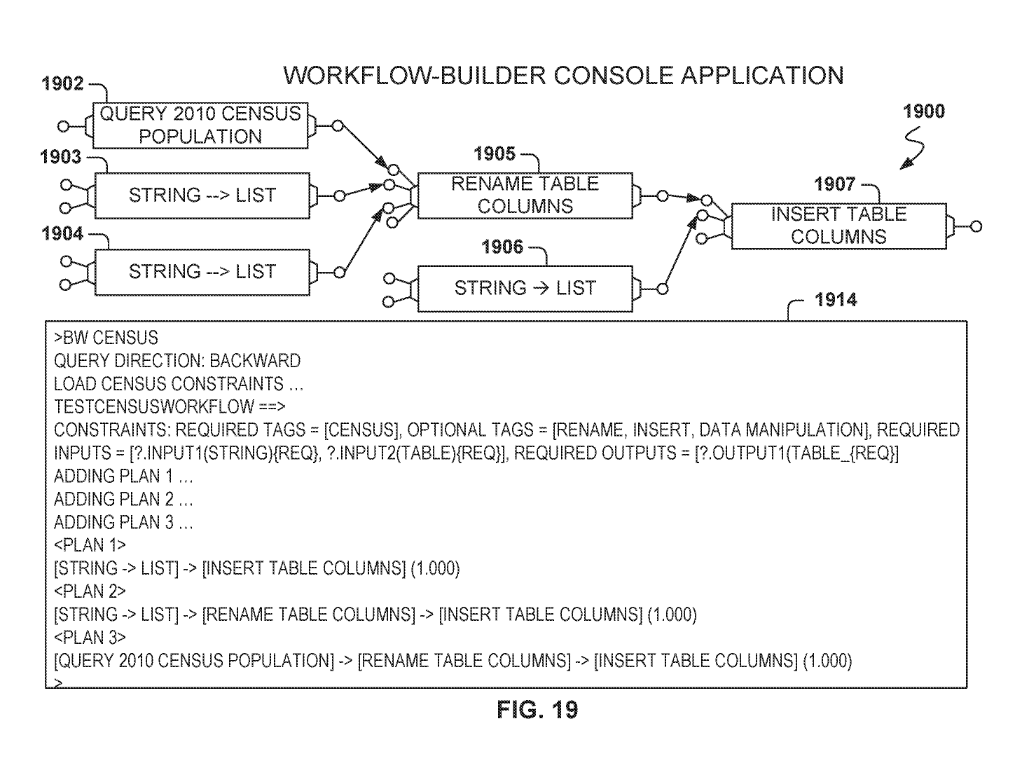

FIG. 19 illustrates an example embodiment of a workflow-builder console application. To facilitate testing and generating workflows, a console application was developed to perform both stepwise and batch workflow construction. The commands supported by the console application, in an example embodiment, are listed in Table 2 below.

TABLE 2

| Command [arg] | Description | Example |
|---|---|---|
| Q | Quit the application | |
| H | Display help menu | |

Configure Constraints

| | | |
|---|---|---|
| (+\|−)t [tags] | Add/delete tag(s) | +t geo,sql |
| (+\|−)rt [tags] | Add/delete required tags | +rt sql |
| (+\|−)i [types] | Add/delete required input types | +i integer |
| (+\|−)o [types] | Add/delete required output types | +o string |
| +c [index] | Add a component to plan by the index to | +c 0 |
| | the recommended list (default = 0) | |
| −c [f\|b] | Delete last-added component in forward | −c b |
| | or backward query direction | |

Reset Constraints

| | |
|---|---|
| xt | Remove all tags |
| xr | Remove all required tags |
| xi | Remove all input types |
| xo | Remove all output types |
| xn | Remove all components stored in the next |
| | sequence |
| xp | Remove all components stored in the next |
| | sequence |
| xc | Clear all constraints(tags, inputs/outputs) |

Display Information

| | | |
|---|---|---|
| lc | List the current recommended component | |
| | list | |
| lw | List all the built-in test workflow names | |
| pp | Print the current workflow plans | |
| pc [index] | Print the component definition in the | pc 0 |
| | recommended list by its index (default = 0) | |

Set/Print parameters

| | | |
|---|---|---|
| sv {bool} | Set/print summary view (true\|false) | sv false |
| rlx {bool} | Set/print relax flag (true\|false) | rlx true |
| nr {num} | Set/print number of query results | |
| spc {name} | Set/print SMB space name | |
| prv {num} | Set/print maximal previous steps allowed | |
| | (<=3) | |
| nxt {num} | Set/print maximal next steps allowed (<=3) | |

Recommend Step/Workflow

| | |
|---|---|
| F | Look 1-step forward using the current |
| | constraints |
| b | Look 1-step backward using the current |
| | constraints |
| fw {workflow} | Build workflow forward using the current |
| | constraints or an existing test workflow |
| | constraints |
| bw {workflow} | Build workflow backward using the current |
| | constraints or an existing test workflow |
| | constraints |
| jp {path} | Export current workflow plans in JSON |
| | format to console (default) or a file path |
| Jw {folder} | Export merged workflow plans in a JEMA |
| | JSON archive to a folder (default folder = |
| | ”.”) |

Interface 1914 illustrates an example interface for entering line commands, for the workflow 1900 shown above that processes census data. In the example embodiment, workflow 1900 includes steps 1902-1907. It is noted that the application may interact with the user to create step-by-step sequences or receive a command to create the complete sequence without further user input.

In other example embodiments (not shown), the user interface may include input fields for entering the different input values, or include command options that open dedicated user interfaces for performing workflow-recommender operations.

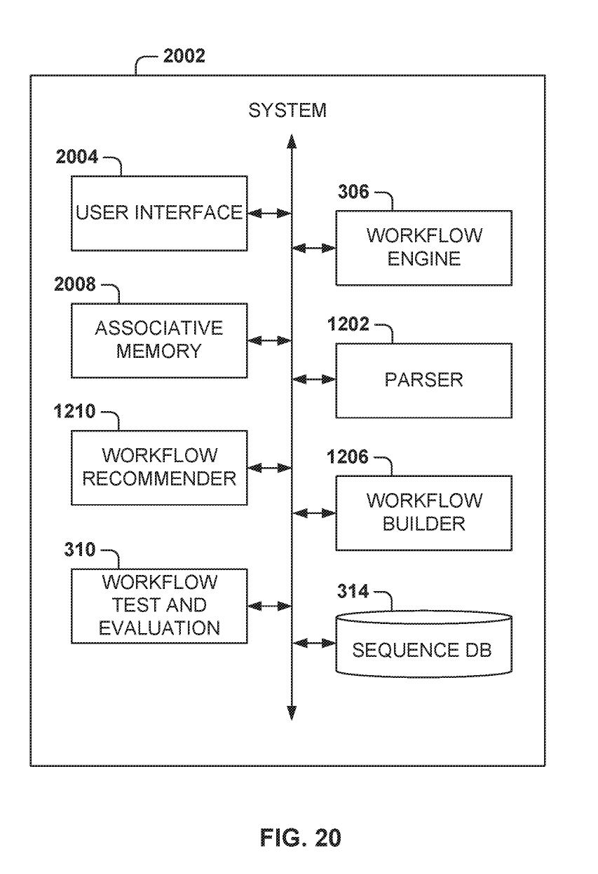

FIG. 20 is a system 2002 for implementing example embodiments. In an example embodiment, the system 2002 includes a user interface 2004, an associative memory 2008, a workflow recommender 1210, a workflow test and evaluation 310, a workflow engine 306, a parser 1202, a workflow builder 1206, and a sequence database 314. The user interface 2004 provides access to the system functionality, such as the user interfaces described in FIGS. 9 and 19.

The associative memory 2008 is a machine-learning algorithm for creating sequences and workflows. The workflow recommender 1210 recommends workflows, as illustrated above with reference to FIG. 12. The workflow test and evaluation 310 is used to assess the validity of the workflow engine 306, as discussed above with reference to FIG. 3.

The workflow engine 306 interacts with other modules, such as the associative memory 2008, to create sequences, as discussed above with reference to FIG. 3. The parser 1202 is used to parse workflow files, and the workflow builder 1206 builds workflows, as illustrated above with reference to FIG. 12. The sequence database 314 is utilized to store sequences and workflows, such as training sequences, recommended sequences, and workflows.

It is noted that the embodiments illustrated in FIG. 20 are examples and do not describe every possible embodiment. Other embodiments may utilize different modules, fewer modules, combine the functionality of two or more modules, etc. The embodiments FIG. 20 should therefore not be interpreted to be exclusive or limiting, but rather illustrative.

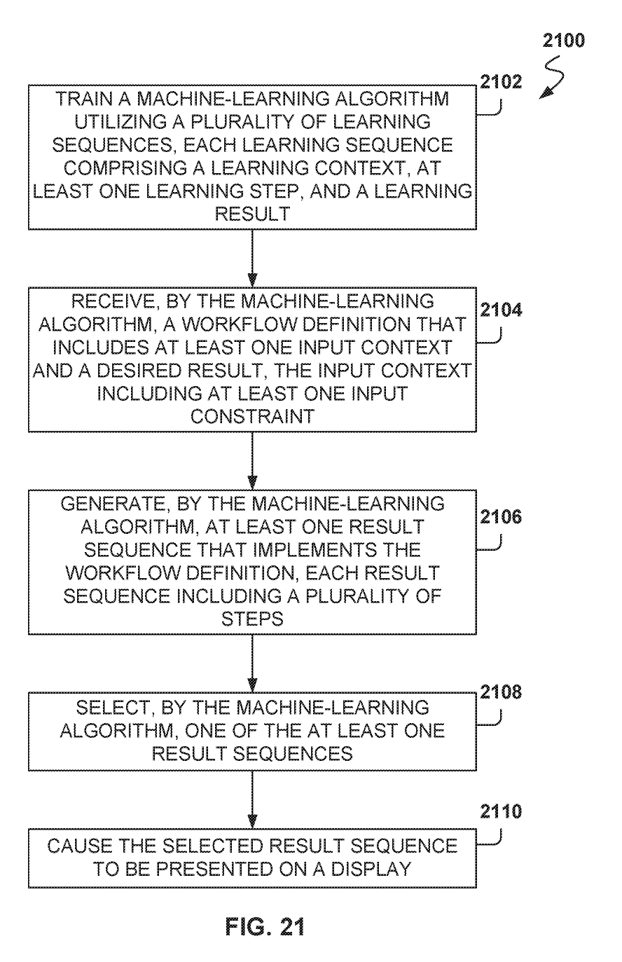

FIG. 21 is a flowchart of a method 2100 for generating workflows, by a computer program, for a desired task. Operation 2102 is for training a machine-learning algorithm utilizing a plurality of learning sequences. Each learning sequence includes a learning context, at least one learning step, and a learning result.

From operation 2102, the method 2100 flows to operation 2104, where the machine-learning algorithm receives a workflow definition that includes at least one input context and a desired result, the input context including at least one input constraint. From operation 2104, the method 2100 flows to operation 2106, where the machine-learning algorithm generates at least one result sequence that implements the workflow definition, each result sequence including a plurality of steps.

From operation 2106, the method 2100 flows to operation 2108 where the machine-learning algorithm selects one sequence as the best sequence. At operation 2110, the selected result sequence is presented on a display. See for example user interfaces presented in FIGS. 9 and 19.

While the various operations in this flowchart are presented and described sequentially, one of ordinary skill will appreciate that some or all of the operations may be executed in a different order, be combined or omitted, or be executed in parallel.

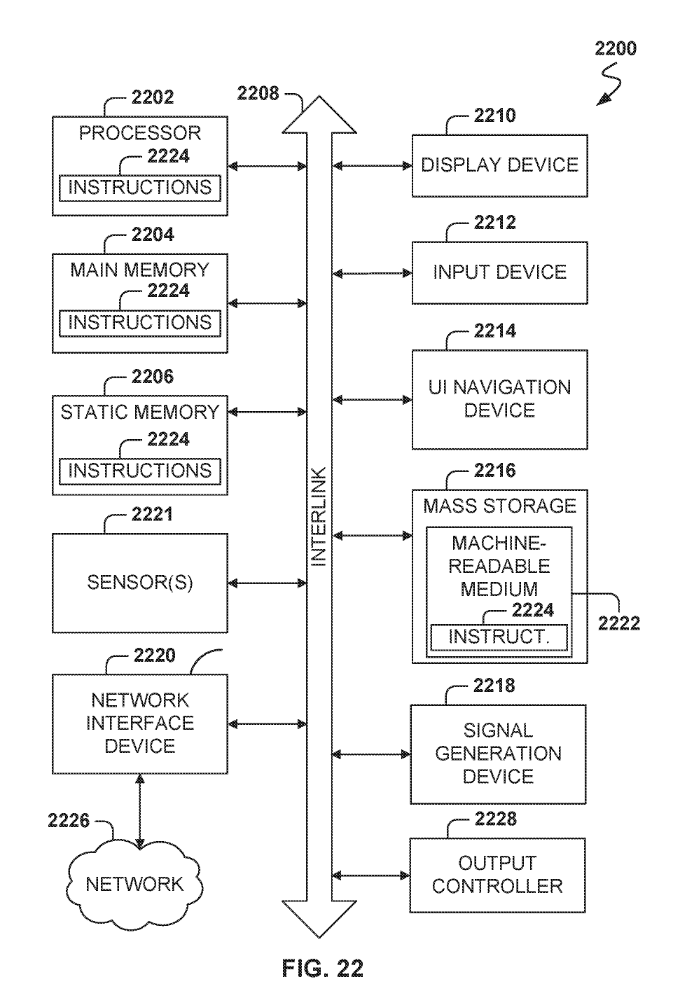

FIG. 22 is a block diagram illustrating an example of a machine 2200 upon which one or more example embodiments may be implemented. In alternative embodiments, the machine 2200 may operate as a standalone device or may be connected (e.g., networked) to other machines. In a networked deployment, the machine 2200 may operate in the capacity of a server machine, a client machine, or both in server-client network environments. In an example, the machine 2200 may act as a peer machine in peer-to-peer (P2P) (or other distributed) network environment. The machine 2200 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 2200 may include a hardware processor 2202 (e.g., a central processing unit (CPU), a graphics processing unit (GPU), a hardware processor core, or any combination thereof), a main memory 2204 and a static memory 2206, some or all of which may communicate with each other via an interlink (e.g., bus) 2208. The machine 2200 may further include a display unit 2210, an alphanumeric input device 2212 (e.g., a keyboard), and a user interface (UI) navigation device 2214 (e.g., a mouse). In an example, the display unit 2210, input device 2212 and UI navigation device 2214 may be a touch screen display. The machine 2200 may additionally include a storage device (e.g., drive unit) 2216, a signal generation device 2218 (e.g., a speaker), a network interface device 2220, and one or more sensors 2221, such as a global positioning system (GPS) sensor, compass, accelerometer, or other sensor. The machine 2200 may include an output controller 2228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 2216 may include a machine readable medium 2222 on which is stored one or more sets of data structures or instructions 2224 (e.g., software) embodying or utilized by any one or more of the techniques or functions described herein. The instructions 2224 may also reside, completely or at least partially, within the main memory 2204, within static memory 2206, or within the hardware processor 2202 during execution thereof by the machine 2200. In an example, one or any combination of the hardware processor 2202, the main memory 2204, the static memory 2206, or the storage device 2216 may constitute machine-readable media.

While the machine readable medium 2222 is illustrated as a single medium, the term “machine readable medium” may include a single medium or multiple media (e.g., a centralized or distributed database, and/or associated caches and servers) configured to store the one or more instructions 2224.

The term “machine readable medium” may include any medium that is capable of storing, encoding, or carrying instructions 2224 for execution by the machine 2200 and that cause the machine 2200 to perform any one or more of the techniques of the present disclosure, or that is capable of storing, encoding or carrying data structures used by or associated with such instructions 2224. Non-limiting machine-readable medium examples may include solid-state memories, and optical and magnetic media. In an example, a massed machine-readable medium comprises a machine readable medium 2222 with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 2224 may further be transmitted or received over a communications network 2226 using a transmission medium via the network interface device 2220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 2220 may include one or more physical jacks (e.g., Ethernet, coaxial, or phone jacks) or one or more antennas to connect to the communications network 2226. In an example, the network interface device 2220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 2224 for execution by the machine 2200, and includes digital or analog communications signals or other intangible medium to facilitate communication of such software.

### ADDITIONAL NOTES & EXAMPLES

Example 1 is a system for creating a workflow, the system comprising: a workflow engine to: train a machine-learning algorithm utilizing a plurality of learning sequences, each learning sequence comprising a learning context, at least one learning step, and a learning result: receive a workflow definition that includes at least one input context and a desired result, the input context including at least one input constraint; generate, utilizing the machine-learning algorithm, at least one result sequence that implements the workflow definition, each result sequence including a plurality of steps; and select one of the at least one result sequence; and a workflow recommender to cause the selected result sequence to be presented on a display.

In Example 2, the subject matter of Example 1 optionally includes wherein the workflow recommender if further to: generate a workflow recommendation for the result sequence, the workflow recommendation comprising a directed graph of steps in the result sequence.

In Example 3, the subject matter of any one or more of Examples 1-2 optionally include wherein to generate the at least one result sequence the workflow engine is further to: identify current steps in the result sequence; identify a current context and semantic attributes to calculate a next step; calculate, by the machine-learning algorithm, a set of candidate next steps based on the current context and the semantic attributes; select the candidate step with a highest ranking from the set of candidate next steps; and iteratively calculate the next step until the result sequence is complete.

In Example 4, the subject matter of Example 3 optionally includes wherein the result sequence is complete when an end marker identified in the desired result is reached.

In Example 5, the subject matter of any one or more of Examples 3-4 optionally include wherein the semantic attributes comprise identifiers for a predetermined numbers of previous steps and identifiers for a predetermined number of next steps.

In Example 6, the subject matter of any one or more of Examples 3-5 optionally include wherein the semantic attributes comprise identifiers for 3 previous steps and an identifier for the next step.

In Example 7, the subject matter of any one or more of Examples 1-6 optionally include wherein to select one of the at least one result sequence the workflow engine is further to: assign a score to each sequence according to a probability that the sequence meets the desired result; and select the sequence with a highest score.

In Example 8, the subject matter of any one or more of Examples 1-7 optionally include wherein the learning step is a task to be performed in the learning sequence, wherein each step from the plurality of steps in the result sequence is a task to be performed in the result sequence.

In Example 9, the subject matter of any one or more of Examples 1-8 optionally include wherein the input constraint includes one or more task preconditions to be met by the result sequence.

In Example 10, the subject matter of any one or more of Examples 1-9 optionally include wherein the input context is any combination selected from a group consisting of a source of data, a goal, an operational condition, and an expected result.

In Example 11, the subject matter of any one or more of Examples 1-10 optionally include wherein each step of the result sequence is associated with at least one constraint identifying preconditions for executing the step.

In Example 12, the subject matter of any one or more of Examples 1-11 optionally include wherein the workflow engine is further to: identify attributes to connect an output from a step in the result sequence to an input of a next step in the result sequence, the attributes including a set of input parameters and corresponding input parameters types.

In Example 13, the subject matter of any one or more of Examples 1-12 optionally include wherein the workflow engine if further to: interact with an associative memory.

Example 14 is a method comprising: training a machine-learning algorithm utilizing a plurality of learning sequences, each learning sequence comprising a learning context, at least one learning step, and a learning result; receiving, by the machine-learning algorithm, a workflow definition that includes at least one input context and a desired result, the input context including at least one input constraint; generating, by the machine-learning algorithm, at least one result sequence that implements the workflow definition, each result sequence including a plurality of steps; selecting, by the machine-learning algorithm, one of the at least one result sequences; and causing the selected result sequence to be presented on a display.

In Example 15, the subject matter of Example 14 optionally includes generating a workflow recommendation for the result sequence, the workflow recommendation comprising a directed graph of steps in the result sequence.

In Example 16, the subject matter of any one or more of Examples 14-15 optionally include wherein generating at least one result sequence further comprises: identifying current steps in the result sequence; identifying a current context and semantic attributes to calculate a next step; calculating, by the machine-learning algorithm, a set of candidate next steps based on the current context and the semantic attributes; selecting the candidate step with a highest ranking from the set of candidate next steps; and iteratively calculating the next step until the result sequence is complete.

In Example 17, the subject matter of Example 16 optionally includes wherein the result sequence is complete when an end marker identified in the desired result is reached.

In Example 18, the subject matter of any one or more of Examples 16-17 optionally include wherein the semantic attributes comprise identifiers for a predetermined numbers of previous steps and identifiers for a predetermined number of next steps.

In Example 19, the subject matter of any one or more of Examples 16-18 optionally include wherein the semantic attributes comprise identifiers for three previous steps and an identifier for the next step.

In Example 20, the subject matter of any one or more of Examples 14-19 optionally include wherein the selecting one of the at least one result sequence further comprises: assigning a score to each sequence according to a probability that the sequence meets the desired result; and selecting the sequence with a highest score.

In Example 21, the subject matter of any one or more of Examples 14-20 optionally include wherein the learning step is a task to be performed in the learning sequence, wherein each step from the plurality of steps in the result sequence is a task to be performed in the result sequence.

In Example 22, the subject matter of any one or more of Examples 14-21 optionally include wherein the input constraint includes one or more task preconditions to be met by the result sequence.

In Example 23, the subject matter of any one or more of Examples 14-22 optionally include wherein the input context is any combination selected from a group consisting of a source of data, a goal, an operational condition, and an expected result.

In Example 24, the subject matter of any one or more of Examples 14-23 optionally include wherein each step of the result sequence is associated with at least one constraint identifying preconditions for executing the step.

In Example 25, the subject matter of any one or more of Examples 14-24 optionally include identifying attributes to connect an output from a step in the result sequence to an input of a next step in the result sequence, the attributes including a set of input parameters and corresponding input parameters types.

In Example 26, the subject matter of any one or more of Examples 14-25 optionally include wherein the machine-learning algorithm interacts with an associative memory.

Example 27 is a system comprising means to perform any method of Examples 14 to 26. Example 28 is at least one machine-readable media including instructions that, when executed by a machine, cause the machine to perform any method of Examples 14-26.

Example 29 is at least one machine readable medium including instructions that, when executed by a machine, cause the machine to: train a machine-learning algorithm utilizing a plurality of learning sequences, each learning sequence comprising a learning context, at least one learning step, and a learning result; receive, by the machine-learning algorithm, a workflow definition that includes at least one input context and a desired result, the input context including at least one input constraint; generate, by the machine-learning algorithm, at least one result sequence that implements the workflow definition, each result sequence including a plurality of steps; select, by the machine-learning algorithm, one of the at least one result sequences; and cause the selected result sequence to be presented on a display.

In Example 30, the subject matter of Example 29 optionally includes wherein the instructions further cause the machine to: generate a workflow recommendation for the result sequence, the workflow recommendation comprising a directed graph of steps in the result sequence.

In Example 31, the subject matter of any one or more of Examples 29-30 optionally include wherein to generate the at least one result sequence the instructions further cause the machine to: identify current steps in the result sequence; identify a current context and semantic attributes to calculate a next step; calculate, by the machine-learning algorithm, a set of candidate next steps based on the current context and the semantic attributes; select the candidate step with a highest ranking from the set of candidate next steps; and iteratively calculate the next step until the result sequence is complete.

In Example 32, the subject matter of Example 31 optionally includes wherein the result sequence is complete when an end marker identified in the desired result is reached.

In Example 33, the subject matter of any one or more of Examples 31-32 optionally include wherein the semantic attributes comprise identifiers for a predetermined numbers of previous steps and identifiers for a predetermined number of next steps.

In Example 34, the subject matter of any one or more of Examples 31-33 optionally include wherein the semantic attributes comprise identifiers for 3 previous steps and an identifier for the next step.

In Example 35, the subject matter of any one or more of Examples 29-34 optionally include wherein to select one of the at least one result sequence the instructions further cause the machine to: assign a score to each sequence according to a probability that the sequence meets the desired result; and select the sequence with a highest score.

In Example 36, the subject matter of any one or more of Examples 29-35 optionally include wherein the learning step is a task to be performed in the learning sequence, wherein each step from the plurality of steps in the result sequence is a task to be performed in the result sequence.

In Example 37, the subject matter of any one or more of Examples 29-36 optionally include wherein the input constraint includes one or more task preconditions to be met by the result sequence.

In Example 38, the subject matter of any one or more of Examples 29-37 optionally include wherein the input context is any combination selected from a group consisting of a source of data, a goal, an operational condition, and an expected result.

In Example 39, the subject matter of any one or more of Examples 29-38 optionally include wherein each step of the result sequence is associated with at least one constraint identifying preconditions for executing the step.

In Example 40, the subject matter of any one or more of Examples 29-39 optionally include wherein the instructions further cause the machine to: identify attributes to connect an output from a step in the result sequence to an input of a next step in the result sequence, the attributes including a set of input parameters and corresponding input parameters types.

In Example 41, the subject matter of any one or more of Examples 29-40 optionally include wherein the instructions further cause the machine to: interact with an associative memory.

Example 42 is a system for creating a workflow, the system comprising: means for training a machine-learning algorithm utilizing a plurality of learning sequences, each learning sequence comprising a learning context, at least one learning step, and a learning result; means for receiving, by the machine-learning algorithm, a workflow definition that includes at least one input context and a desired result, the input context including at least one input constraint; means for generating, by the machine-learning algorithm, at least one result sequence that implements the workflow definition, each result sequence including a plurality of steps; means for selecting, by the machine-learning algorithm, one of the at least one result sequences; and means for causing the selected result sequence to be presented on a display.

In Example 43, the subject matter of Example 42 optionally includes means for generating a workflow recommendation for the result sequence, the workflow recommendation comprising a directed graph of steps in the result sequence.

In Example 44, the subject matter of any one or more of Examples 42-43 optionally include wherein generating at least one result sequence further comprises: means for identifying current steps in the result sequence; means for identifying a current context and semantic attributes to calculate a next step; means for calculating, by the machine-learning algorithm, a set of candidate next steps based on the current context and the semantic attributes; means for selecting the candidate step with a highest ranking from the set of candidate next steps; and means for iteratively calculating the next step until the result sequence is complete.

In Example 45, the subject matter of Example 44 optionally includes wherein the result sequence is complete when an end marker identified in the desired result is reached.

In Example 46, the subject matter of any one or more of Examples 44-45 optionally include wherein the semantic attributes comprise identifiers for a predetermined numbers of previous steps and identifiers for a predetermined number of next steps.

In Example 47, the subject matter of any one or more of Examples 44-46 optionally include wherein the semantic attributes comprise identifiers for 44 previous steps and an identifier for the next step.

In Example 48, the subject matter of any one or more of Examples 42-47 optionally include wherein the selecting one of the at least one result sequence further comprises: means for assigning a score to each sequence according to a probability that the sequence meets the desired result; and means for selecting the sequence with a highest score.

In Example 49, the subject matter of any one or more of Examples 42-48 optionally include wherein the learning step is a task to be performed in the learning sequence, wherein each step from the plurality of steps in the result sequence is a task to be performed in the result sequence.

In Example 50, the subject matter of any one or more of Examples 42-49 optionally include wherein the input constraint includes one or more task preconditions to be met by the result sequence.

In Example 51, the subject matter of any one or more of Examples 42-50 optionally include wherein the input context is any combination selected from a group consisting of a source of data, a goal, an operational condition, and an expected result.

In Example 52, the subject matter of any one or more of Examples 42-51 optionally include wherein each step of the result sequence is associated with at least one constraint identifying preconditions for executing the step.

In Example 53, the subject matter of any one or more of Examples 42-52 optionally include means for identifying attributes to connect an output from a step in the result sequence to an input of a next step in the result sequence, the attributes including a set of input parameters and corresponding input parameters types.

In Example 54, the subject matter of any one or more of Examples 42-53 optionally include wherein the machine-learning algorithm interacts with an associative memory.

Example 55 is a system for creating a workflow, the system comprising: a sequence generator to: receive a plurality of training sequences; and parse the training sequences to extract order of steps in each training sequence, contexts for each step, and constraints for each step; a workflow engine to train a machine-learning algorithm utilizing the training sequences and the extracted order of steps, contexts, and constraints, the machine-learning algorithm being trained to predict a next step given previous steps, current contexts, current constraints, and a desired result; and a workflow recommender to test a subset of the training sequences, the testing for each training sequence comprising operations to: input an input sequence and the desired result to the workflow recommender; utilize the machine-learning algorithm to build an output workflow by iteratively calculating the next step until the desired result is reached; and compare the output workflow to the corresponding training sequence, the workflow recommender being evaluated based on the comparing for the subset of the training sequences.

In Example 56, the subject matter of Example 55 optionally includes wherein the parse of the training sequences further comprises encoding each step utilizing information about a window of steps around the step.

In Example 57, the subject matter of any one or more of Examples 55-56 optionally include wherein the contexts of a step comprise at least one precondition to execute the step, each precondition being selected from a group consisting of a source, a goal, a pre-requisite, a condition, and a result from executing the step.

In Example 58, the subject matter of any one or more of Examples 55-57 optionally include wherein the constraints of a step comprises at least one required precondition that the step must meet for having a valid sequence.

In Example 59, the subject matter of any one or more of Examples 55-58 optionally include wherein the input sequence further comprises an initial step, contexts for the next step, and constraints for the next step.

In Example 60, the subject matter of any one or more of Examples 55-59 optionally include wherein the input sequence further comprises a plurality of previous steps, contexts of an initial step, and constraints of the initial step.

In Example 61, the subject matter of any one or more of Examples 55-60 optionally include wherein the sequence is an ordered list of tasks, wherein the output workflow comprises an output sequence and a directed graph of tasks in the output sequence.

In Example 62, the subject matter of any one or more of Examples 55-61 optionally include wherein the parse of the training sequences further comprises utilizing predefined construction rules to validate each training sequence.

In Example 63, the subject matter of any one or more of Examples 55-62 optionally include wherein to receive the plurality of training sequences the sequence generator is further to generate the training sequences.

In Example 64, the subject matter of any one or more of Examples 55-63 optionally include wherein the parse of the training sequences further comprises coding each step include information about a predetermined number of previous steps in the sequence and about a predetermined number of following steps in the sequence.

In Example 65, the subject matter of Example 64 optionally includes wherein the predetermined number of previous steps in the sequence is three and the predetermined number of following steps in the sequence is one.

In Example 66, the subject matter of any one or more of Examples 55-65 optionally include wherein to calculate the next step the workflow recommender is further to: identify a plurality of candidate next steps that meet current contexts and constraints; rank the candidate next steps; and select the next step based on the ranking.

In Example 67, the subject matter of any one or more of Examples 55-66 optionally include wherein to test the subset of the training sequences, the workflow recommender is further to: identify a plurality of candidate valid sequences; rank each candidate valid sequences; and select the best candidate valid sequence based on the ranking.

Example 68 is a method comprising: receiving a plurality of training sequences; parsing the training sequences to extract order of steps in each training sequence, contexts for each step, and constraints for each step: training a machine-learning algorithm utilizing the training sequences and the extracted order of steps, contexts, and constraints, the machine-learning algorithm being trained to predict a next step given previous steps, current contexts, current constraints, and a desired result; testing a workflow recommender with a subset of the training sequences, the testing for each training sequence comprising: inputting an input sequence and the desired result to the workflow recommender; utilizing the machine-learning algorithm to build an output workflow by iteratively calculating the next step until the desired result is reached; and comparing the output workflow to the corresponding training sequence; and evaluating the workflow recommender based on the comparing for the subset of the training sequences.

In Example 69, the subject matter of Example 68 optionally includes wherein the parsing the training sequences further comprises: encoding each step utilizing information about a window of steps around the step.

In Example 70, the subject matter of any one or more of Examples 68-69 optionally include wherein the contexts of a step comprise at least one precondition to execute the step, each precondition being selected from a group consisting of a source, a goal, a pre-requisite, a condition, and a result from executing the step.

In Example 71, the subject matter of any one or more of Examples 68-70 optionally include wherein the constraints of a step comprises at least one required precondition that the step must meet for having a valid sequence.

In Example 72, the subject matter of any one or more of Examples 68-71 optionally include wherein the input sequence further comprises an initial step, contexts for the next step, and constraints for the next step.

In Example 73, the subject matter of any one or more of Examples 68-72 optionally include wherein the input sequence further comprises a plurality of previous steps, contexts of an initial step, and constraints of the initial step.

In Example 74, the subject matter of any one or more of Examples 68-73 optionally include wherein the sequence is an ordered list of tasks, wherein the output workflow comprises an output sequence and a directed graph of tasks in the output sequence.

In Example 75, the subject matter of any one or more of Examples 68-74 optionally include wherein the parsing the training sequences further comprises: utilizing predefined construction rules to validate each training sequence.

In Example 76, the subject matter of any one or more of Examples 68-75 optionally include wherein the receiving the plurality of training sequences further comprises: generating the training sequences by a sequence generator.

In Example 77, the subject matter of any one or more of Examples 68-76 optionally include wherein the parsing the training sequences further comprises: coding each step include information about a predetermined number of previous steps in the sequence and about a predetermined number of following steps in the sequence.

In Example 78, the subject matter of Example 77 optionally includes wherein the predetermined number of previous steps in the sequence is three and the predetermined number of following steps in the sequence is one.

In Example 79, the subject matter of any one or more of Examples 68-78 optionally include wherein calculating the next step further comprises: identifying a plurality of candidate next steps that meet current contexts and constraints; ranking the candidate next steps; and selecting the next step based on the ranking.

In Example 80, the subject matter of any one or more of Examples 68-79 optionally include wherein the testing the workflow recommender further comprises: identifying a plurality of candidate valid sequences; ranking each candidate valid sequences; and selecting the best candidate valid sequence based on the ranking.

Example 81 is a system comprising means to perform any method of Examples 68 to 80.

Example 82 is at least one machine-readable media including instructions that, when executed by a machine, cause the machine to perform any method of Examples 68-80.

Example 83 is at least one machine readable medium including instructions that, when executed by a machine, cause the machine to: receive a plurality of training sequences; parse the training sequences to extract order of steps in each training sequence, contexts for each step, and constraints for each step; train a machine-learning algorithm utilizing the training sequences and the extracted order of steps, contexts, and constraints, the machine-learning algorithm being trained to predict a next step given previous steps, current contexts, current constraints, and a desired result; test a workflow recommender with a subset of the training sequences, the testing for each training sequence comprising: input an input sequence and the desired result to the workflow recommender; utilize the machine-learning algorithm to build an output workflow by iteratively calculating the next step until the desired result is reached; and compare the output workflow to the corresponding training sequence; and evaluate the workflow recommender based on the comparing for the subset of the training sequences.

In Example 84, the subject matter of Example 83 optionally includes wherein to parse the training sequences the instructions further cause the machine to: encode each step utilizing information about a window of steps around the step.

In Example 85, the subject matter of any one or more of Examples 83-84 optionally include wherein the contexts of a step comprise at least one precondition to execute the step, each precondition being selected from a group consisting of a source, a goal, a pre-requisite, a condition, and a result from executing the step.

In Example 86, the subject matter of any one or more of Examples 83-85 optionally include wherein the constraints of a step comprises at least one required precondition that the step must meet for having a valid sequence.

In Example 87, the subject matter of any one or more of Examples 83-86 optionally include wherein the input sequence further comprises an initial step, contexts for the next step, and constraints for the next step.

In Example 88, the subject matter of any one or more of Examples 83-87 optionally include wherein the input sequence further comprises a plurality of previous steps, contexts of an initial step, and constraints of the initial step.

In Example 89, the subject matter of any one or more of Examples 83-88 optionally include wherein the sequence is an ordered list of tasks, wherein the output workflow comprises an output sequence and a directed graph of tasks in the output sequence.

In Example 90, the subject matter of any one or more of Examples 83-89 optionally include wherein to parse the training sequences the instructions further cause the machine to: utilize predefined construction rules to validate each training sequence.

In Example 91, the subject matter of any one or more of Examples 83-90 optionally include wherein to receive the plurality of training sequences the instructions further cause the machine to: generate the training sequences by a sequence generator.

In Example 92, the subject matter of any one or more of Examples 83-91 optionally include wherein to parse the training sequences the instructions further cause the machine to: code each step include information about a predetermined number of previous steps in the sequence and about a predetermined number of following steps in the sequence.

In Example 93, the subject matter of Example 92 optionally includes wherein the predetermined number of previous steps in the sequence is three and the predetermined number of following steps in the sequence is one.

In Example 94, the subject matter of any one or more of Examples 83-93 optionally include wherein to calculate the next step the instructions further cause the machine to: identify a plurality of candidate next steps that meet current contexts and constraints; rank the candidate next steps; and select the next step based on the ranking.

In Example 95, the subject matter of any one or more of Examples 83-94 optionally include wherein to test the workflow recommender the instructions further cause the machine to: identify a plurality of candidate valid sequences; rank each candidate valid sequences; and select the best candidate valid sequence based on the ranking.

Example 96 is a system for creating a workflow, the system comprising: means for receiving a plurality of training sequences; parsing the training sequences to extract order of steps in each training sequence, contexts for each step, and constraints for each step; means for training a machine-learning algorithm utilizing the training sequences and the extracted order of steps, contexts, and constraints, the machine-learning algorithm being trained to predict a next step given previous steps, current contexts, current constraints, and a desired result; means for testing a workflow recommender with a subset of the training sequences, the testing for each training sequence comprising: inputting an input sequence and the desired result to the workflow recommender; utilizing the machine-learning algorithm to build an output workflow by iteratively calculating the next step until the desired result is reached; and comparing the output workflow to the corresponding training sequence; and means for evaluating the workflow recommender based on the comparing for the subset of the training sequences.

In Example 97, the subject matter of Example 96 optionally includes wherein the parsing the training sequences further comprises: encoding each step utilizing information about a window of steps around the step.

In Example 98, the subject matter of any one or more of Examples 96-97 optionally include wherein the contexts of a step comprise at least one precondition to execute the step, each precondition being selected from a group consisting of a source, a goal, a pre-requisite, a condition, and a result from executing the step.

In Example 99, the subject matter of any one or more of Examples 96-98 optionally include wherein the constraints of a step comprises at least one required precondition that the step must meet for having a valid sequence.

In Example 100, the subject matter of any one or more of Examples 96-99 optionally include wherein the input sequence further comprises an initial step, contexts for the next step, and constraints for the next step.

In Example 101, the subject matter of any one or more of Examples 96-100 optionally include wherein the input sequence further comprises a plurality of previous steps, contexts of an initial step, and constraints of the initial step.

In Example 102, the subject matter of any one or more of Examples 96-101 optionally include wherein the sequence is an ordered list of tasks, wherein the output workflow comprises an output sequence and a directed graph of tasks in the output sequence.

In Example 103, the subject matter of any one or more of Examples 96-102 optionally include wherein the parsing the training sequences further comprises: utilizing predefined construction rules to validate each training sequence.

In Example 104, the subject matter of any one or more of Examples 96-103 optionally include wherein the receiving the plurality of training sequences further comprises: generating the training sequences by a sequence generator.

In Example 105, the subject matter of any one or more of Examples 96-104 optionally include wherein the parsing the training sequences further comprises: coding each step include information about a predetermined number of previous steps in the sequence and about a predetermined number of following steps in the sequence.

In Example 106, the subject matter of Example 105 optionally includes wherein the predetermined number of previous steps in the sequence is three and the predetermined number of following steps in the sequence is one.

In Example 107, the subject matter of any one or more of Examples 96-106 optionally include wherein calculating the next step further comprises: identifying a plurality of candidate next steps that meet current contexts and constraints, ranking the candidate next steps; and selecting the next step based on the ranking.

In Example 108, the subject matter of any one or more of Examples 96-107 optionally include wherein the testing the workflow recommender further comprises: identifying a plurality of candidate valid sequences; ranking each candidate valid sequences; and selecting the best candidate valid sequence based on the ranking.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for creating a workflow, the system comprising:
a workflow engine to:
train a machine-learning algorithm utilizing a plurality of learning sequences, each learning sequence comprising a learning context, at least one learning step, and a learning result;
receive a workflow definition that includes at least one input context and a desired result, the input context including at least one input constraint;
generate, utilizing the machine-learning algorithm, at least one result sequence that implements the workflow definition, each result sequence including a plurality of steps; and
select one of the at least one result sequence; and
a workflow recommender to cause the selected result sequence to be presented on a display.

2. The system as recited in claim 1, wherein the workflow recommender if further to:
generate a workflow recommendation for the result sequence, the workflow recommendation comprising a directed graph of steps in the result sequence.

3. The system as recited in claim 1, wherein to generate the at least one result sequence the workflow engine is further to:
identify current steps in the result sequence;
identify a current context and semantic attributes to calculate a next step;
calculate, by the machine-learning algorithm, a set of candidate next steps based on the current context and the semantic attributes;
select the candidate step with a highest ranking from the set of candidate next steps; and
iteratively calculate the next step until the result sequence is complete.

4. The system as recited in claim 3, wherein the result sequence is complete when an end marker identified in the desired result is reached.

5. The system as recited in claim 3, wherein the semantic attributes comprise identifiers for a predetermined numbers of previous steps and identifiers for a predetermined number of next steps.

6. The system as recited in claim 3, wherein the semantic attributes comprise identifiers for 3 previous steps and an identifier for the next step.

7. The system as recited in claim 1, wherein to select one of the at least one result sequence the workflow engine is further to:
assign a score to each sequence according to a probability that the sequence meets the desired result; and
select the sequence with a highest score.

8. The system as recited in claim 1, wherein the learning step is a task to be performed in the learning sequence, wherein each step from the plurality of steps in the result sequence is a task to be performed in the result sequence.

9. The system as recited in claim 1, wherein the input constraint includes one or more task preconditions to be met by the result sequence.

10. The system as recited in claim 1, wherein the input context is any combination selected from a group consisting of a source of data, a goal, an operational condition, and an expected result.

11. A method for creating a workflow, the method comprising:
training a machine-learning algorithm utilizing a plurality of learning sequences, each learning sequence comprising a learning context, at least one learning step, and a learning result;
receiving, by the machine-learning algorithm, a workflow definition that includes at least one input context and a desired result, the input context including at least one input constraint;
generating, by the machine-learning algorithm, at least one result sequence that implements the workflow definition, each result sequence including a plurality of steps;
selecting, by the machine-learning algorithm, one of the at least one result sequences; and
causing the selected result sequence to be presented on a display.

12. The method as recited in claim 11, further comprising:
generating a workflow recommendation for the result sequence, the workflow recommendation comprising a directed graph of steps in the result sequence.

13. The method as recited in claim 11, wherein generating at least one result sequence further comprises:
identifying current steps in the result sequence;
identifying a current context and semantic attributes to calculate a next step;
calculating, by the machine-learning algorithm, a set of candidate next steps based on the current context and the semantic attributes;
selecting the candidate step with a highest ranking from the set of candidate next steps; and
iteratively calculating the next step until the result sequence is complete.

14. The method as recited in claim 13, wherein the semantic attributes comprise identifiers for a predetermined numbers of previous steps and identifiers for a predetermined number of next steps.

15. The method as recited in claim 11, wherein the learning step is a task to be performed in the learning sequence, wherein each step from the plurality of steps in the result sequence is a task to be performed in the result sequence.

16. The method as recited in claim 11, wherein the input constraint includes one or more task preconditions to be met by the result sequence.

17. The method as recited in claim 11, wherein the input context is any combination selected from a group consisting of a source of data, a goal, an operational condition, and an expected result.

18. At least one machine readable medium including instructions that, when executed by a machine, cause the machine to:
train a machine-learning algorithm utilizing a plurality of learning sequences, each learning sequence comprising a learning context, at least one learning step, and a learning result;
receive, by the machine-learning algorithm, a workflow definition that includes at least one input context and a desired result, the input context including at least one input constraint;
generate, by the machine-learning algorithm, at least one result sequence that implements the workflow definition, each result sequence including a plurality of steps;
select, by the machine-learning algorithm, one of the at least one result sequences; and
cause the selected result sequence to be presented on a display.

19. The at least one machine readable medium of claim 18, wherein the instructions further cause the machine to:
generate a workflow recommendation for the result sequence, the workflow recommendation comprising a directed graph of steps in the result sequence.

20. The at least one machine readable medium of claim 18, wherein to generate the at least one result sequence the instructions further cause the machine to:
identify current steps in the result sequence;
identify a current context and semantic attributes to calculate a next step;
calculate, by the machine-learning algorithm, a set of candidate next steps based on the current context and the semantic attributes;
select the candidate step with a highest ranking from the set of candidate next steps; and
iteratively calculate the next step until the result sequence is complete.

21. The at least one machine readable medium of claim 20, wherein the result sequence is complete when an end marker identified in the desired result is reached.

22. The at least one machine readable medium of claim 20, wherein the semantic attributes comprise identifiers for a predetermined numbers of previous steps and identifiers for a predetermined number of next steps.

23. The at least one machine readable medium of claim 20, wherein the semantic attributes comprise identifiers for 3 previous steps and an identifier for the next step.

24. The at least one machine readable medium of claim 18, wherein the sequence is an ordered list of tasks, wherein the output workflow comprises an output sequence and a directed graph of tasks in the output sequence.

25. The at least one machine readable medium of claim 18, wherein to parse the training sequences the instructions further cause the machine to:
utilize predefined construction rules to validate each training sequence.
